(19) United States
(12) Patent Application Publication
(10) Pub. No.: US 2018/0029447 A1
(43) Pub. Date: Feb. 1, 2018

(54) HUMIDIFICATION DEVICE AND AIR CONDITIONER FOR VEHICLE

(71) Applicant: DENSO CORPORATION, Kariya-city, Aichi-pref. (JP)

(72) Inventors: Shinya KATO, Kariya-city (JP); Koji ITO, Kariya-city (JP); Takahito NAKAMURA, Kariya-city (JP); Yasuhiro SEKITO, Kariya-city (JP); Daisuke SAKAKIBARA, Kariya-city (JP); Jun YAMAOKA, Kariya-city (JP)

(73) Assignee: DENSO CORPORATION, Kariya-city, Aichi-pref. (JP)

(21) Appl. No.: 15/551,947

(22) PCT Filed: Feb. 24, 2016
(86) PCT No.: PCT/JP2016/055401

§ 371 Date: Aug. 18, 2017

(30) Foreign Application Priority Data
Mar. 19, 2015 (JP) 2015-056257
Mar. 31, 2015 (JP) 2015-072751

(51) Int. Cl. B60H 3/02; B60H 1/32; B60H 1/00

(52) U.S. Cl. CPC B60H 3/02; B60H 1/00021; B60H 1/00671; B60H 1/00849; B60H 1/3204; B60H 2001/00721

(57) ABSTRACT

A humidification device for a vehicle air conditioner includes an adsorber having an adsorbent, an adsorption case configured to provide an accommodating space that accommodates the adsorber and includes a moisture-adsorption space and a moisture-desorption space, a humidification-side guiding portion that guides humidification air humidified by using the moisture desorbed within the moisture-desorption space to a vehicle interior, a moving mechanism that moves at least a part of the adsorbent existing in the moisture-adsorption space of the adsorber to the moisture-desorption space while moving at least a part of the adsorbent existing in the moisture-desorption space of the adsorber to the moisture-adsorption space, and a desorption control unit that executes a desorption operation to desorb moisture adsorbed in the adsorbent when humidification of the vehicle interior is stopped.

### CROSS REFERENCE TO RELATED APPLICATION

The application is based on Japanese Patent Applications No. 2015-056257 filed on Mar. 19, 2015, and No. 2015-072751 filed on Mar. 31, 2015, the contents of which are incorporated herein by reference in its entirety.

### FIELD OF THE INVENTION

The present disclosure relates to a humidification device applied to an air-conditioning unit, and a vehicle air conditioner that includes the air-conditioning unit and the humidification device.

### BACKGROUND ART

Conventionally, there is a known air-conditioning unit for a vehicle equipped with a humidifier that humidifies the vehicle interior (see, for example, Patent Document 1). Patent Document 1 discloses an air-conditioning unit that includes permeable tubes designed to vaporize water and disposed in a duct to guide temperature-adjusted air into the vehicle interior, so that water stored in a tank is supplied to the permeable tubes, thereby humidifying the air before it is blown into the vehicle interior.

### RELATED ART DOCUMENT

### Patent Document

Patent Document 1: Japanese Unexamined Patent Application Publication No. 2005-282992

### SUMMARY OF INVENTION

However, in the technique disclosed in Patent Document 1, the amount of water in the tank is gradually decreased along with the humidification of the vehicle interior as the water is supplied to the permeable tubes. The tank needs to be replenished with water.

In vehicles as a movable body, there is a limitation on the amount of water for replenishing the tank. If the water in the tank and water for replenishing the tank fail to be adequately ensured, the vehicle interior cannot be humidified continuously.

It is a first object of the present disclosure to humidify the vehicle interior without supplying water from the outside of a vehicle air conditioner.

It is a second object of the present disclosure to provide a humidification device and a vehicle air conditioner that can continuously humidify the vehicle interior.

It is a third object of the present disclosure to reduce the influence on the temperature control and the air-distribution ratio of ventilation air in a vehicle air conditioner. The vehicle air conditioner is one that guides ventilation air having temperatures controlled independently to different sites of the vehicle interior. Alternatively, the vehicle air conditioner is one that has a ventilation passage through which outside air passes and another ventilation passage through which inside air passes.

According to an aspect of the present disclosure, a humidification device is usable for an air-conditioning unit that accommodates a cooling portion for cooling ventilation air and a heating portion for heating ventilation air, in an air-conditioning case that forms a ventilation passage for the ventilation air into the vehicle interior.

The humidification device includes: an adsorber including an adsorbent that adsorbs and desorbs moisture; an adsorption case configured to provide an accommodating space that accommodates the adsorber, the accommodating space including a moisture-adsorption space and a moisture-desorption space, the moisture-adsorption space being configured to adsorb moisture contained in cooled air, produced by the cooling portion, into the adsorbent by circulating the cooled air, the moisture-desorption space being configured to desorb the moisture adsorbed in the adsorbent by circulating heated air produced by the heating portion; a humidification-side guiding portion that guides humidification air humidified by using the moisture desorbed within the moisture-desorption space, to the vehicle interior; and a moving mechanism that moves at least a part of the adsorbent existing in the moisture-adsorption space of the adsorber to the moisture-desorption space, while moving at least a part of the adsorbent existing in the moisture-desorption space of the adsorber to the moisture-adsorption space.

According to another aspect of the present disclosure, an air conditioner for a vehicle includes:

an air-conditioning unit configured to accommodate a cooling portion that cools ventilation air and a heating portion that heats the ventilation air, in an air-conditioning case provided with a ventilation passage for the ventilation air into a vehicle interior; and

a humidification device that desorbs moisture adsorbed in an adsorbent of an adsorber, humidifies air with the moisture desorbed from the adsorbent, and guides the humidification air to the vehicle interior.

In the air conditioner for a vehicle, the humidification device includes:

an adsorption case configured to provide an accommodating space that accommodates the adsorber, the accommodating space including a moisture-adsorption space and a moisture-desorption space, the moisture-adsorption space being configured to adsorb moisture contained in cooled air, produced by the cooling portion, into the adsorbent by circulating the cooled air, the moisture-desorption space being configured to desorb the moisture adsorbed in the adsorbent by circulating heated air produced by the heating portion; and

a moving mechanism that moves at least a part of the adsorbent existing in the moisture-desorption space of the adsorber to the moisture-adsorption space, while moving at least a part of the adsorbent existing in the moisture-adsorption space of the adsorber to the moisture-desorption space.

Thus, the moisture of the cooled air produced by the air-conditioning unit can be used to humidify the vehicle interior, and thereby there is no need for water to be supplied from the outside of the vehicle air conditioner. The moisture adsorbed into the adsorbent in the moisture-adsorption space can be desorbed from the adsorbent in the moisture-desorption space, thereby humidifying the heated air with the moisture. Concurrently, the adsorbent desorbing the moisture in the moisture-desorption space can adsorb the moisture of the cooled air circulating through the moisture-adsorption space. Thus, the continuous humidification of the vehicle interior can be performed.

An air conditioner for a vehicle according to another aspect of the present disclosure includes:

an air-conditioning unit configured to accommodate a cooling portion that cools ventilation air and a heating portion that heats the ventilation air, in an air-conditioning case, the air-conditioning case being provided with a first ventilation passage and a second ventilation passage that are configured to guide the ventilation air having temperatures controlled independently to different areas of a vehicle interior; and

a humidification device that desorbs moisture adsorbed in an adsorbent of an adsorber, humidifies air with the moisture desorbed from the adsorbent, and guides the humidification air to the vehicle interior.

Furthermore, the humidification device includes:

a cold-air introduction passage that guides the cooled air produced by the cooling portion from both the first ventilation passage and the second ventilation passage to the adsorber, as air that causes moisture to be adsorbed into the adsorbent;

a pre-humidification air passage that guides pre-humidification air, which causes moisture adsorbed in the adsorbent to be desorbed from the adsorbent, to the adsorber; and

a post-humidification air passage that guides post-humidification air, which is humidified by the moisture desorbed within the adsorption case, to the vehicle interior.

The moisture of the cooled air produced by the air-conditioning unit can be used to humidify the vehicle interior, so that the vehicle interior can be humidified without being supplied with water from the outside of the vehicle air conditioner.

If the cooled air for adsorbing moisture into the adsorbent is taken out of one of the first and second ventilation passages and then guided to the adsorber, only the volume of the air in one ventilation passage would vary depending on the ON or OFF status of the humidification device. Such variations in the air volume might adversely affect the temperature control and the air-distribution ratio of the ventilation air in the first and second ventilation passages.

In contrast, in the configuration in which the cooled air is taken out of both the first ventilation passage and the second ventilation passage and then guided to the adsorber, the cooled air can be taken in the vehicle air conditioner substantially uniformly from both the first and second ventilation passages. Such an arrangement can reduce the influence on the temperature control and the air-distribution ratio of the ventilation air in the first and second ventilation passages.

According to another aspect of the present disclosure, an air conditioner for a vehicle includes:

an air-conditioning unit configured to accommodate a cooling portion that cools air and a heating portion that heats the air, in an air-conditioning case, the air-conditioning case being provided with an outside-air ventilation passage and an inside-air ventilation passage, the outside-air ventilation passage being configured to guide the air introduced from an outside of the vehicle into a vehicle interior, the inside-air ventilation passage being configured to guide the air introduced from the vehicle interior to the vehicle interior; and

a humidification device that desorbs moisture adsorbed in an adsorbent of an adsorber, humidifies air with the moisture desorbed from the adsorbent, and guides the humidification air to the vehicle interior.

Furthermore, the humidification device includes:

a cold-air introduction passage that guides the cooled air, produced by the cooling portion, from the outside-air ventilation passage to the adsorber, as air that causes moisture to be adsorbed into the adsorbent;

a pre-humidification air passage that guides pre-humidification air, heated by the heating portion, from the inside-air ventilation passage to the adsorber, as air that causes moisture adsorbed in the adsorbent to be desorbed from the adsorbent; and

a post-humidification air passage that guides post-humidification air, humidified by the moisture desorbed within the adsorption case, to the vehicle interior.

The moisture of the cooled air produced by the air-conditioning unit can be used to humidify the vehicle interior, so that the vehicle interior can be humidified without being supplied with water from the outside of the vehicle air conditioner.

For example, during air-cooling in summer, the relative humidity of the outside air tends to become higher than the relative humidity of the inside air. The cooled air for adsorbing moisture into the adsorbent is taken out of the outside-air ventilation passage, and the pre-humidification air for desorbing moisture adsorbed in the adsorbent is taken out of the inside-air ventilation passage. Consequently, a difference in the relative humidity between the cooled air and the pre-humidification air can be enlarged. Accordingly, the efficiency of the adsorbent is improved, and thereby the high-humidity air can be supplied to the vehicle interior.

Further, the air guided to the adsorber is taken out of both the outside-air ventilation passage and the inside-air ventilation passage, thereby making it possible to reduce the influence on the temperature control and the air-distribution ratio of the ventilation air in the outside-air ventilation passage and the inside-air ventilation passage.

### BRIEF DESCRIPTION OF THE DRAWINGS

FIG. 1 is a schematic cross-sectional view showing an entire structure of a vehicle air conditioner that includes a humidification device according to a first embodiment.

FIG. 2 is a cross-sectional view taken along the line II-II of FIG. 1.

FIG. 3 is a perspective view showing a main part of the humidification device according to the first embodiment.

FIG. 4 is a fragmentary view taken in the direction of the arrow IV of FIG. 3.

FIG. 5 is a perspective view showing an outline structure of a heat exchanger according to the first embodiment.

FIG. 6 is a block diagram showing a configuration of a controller for the humidification device and an air-conditioning unit according to the first embodiment.

FIG. 7 is a flowchart showing the flow of control processing for the humidification device that is executed by the controller according to the first embodiment.

FIG. 8 is a schematic cross-sectional view showing an operating state of the humidification device and the air-conditioning unit according to the first embodiment.

FIG. 9 is a schematic cross-sectional view showing an entire structure of a vehicle air conditioner that includes a humidification device according to a second embodiment.

FIG. 10 is a schematic cross-sectional view showing an entire structure of a vehicle air conditioner that includes a humidification device according to a third embodiment.

FIG. 11 is a schematic cross-sectional view showing an entire structure of a vehicle air conditioner according to a fourth embodiment.

FIG. 12 is a cross-sectional view taken along the line XII-XII of FIG. 11.

FIG. 13 is a schematic cross-sectional view showing an entire structure of a vehicle air conditioner according to a fifth embodiment.

FIG. 14 is a cross-sectional view taken along the line XIV-XIV of FIG. 13.

FIG. 15 is a schematic cross-sectional view showing a modified example of the vehicle air conditioner according to the fifth embodiment.

FIG. 16 is a schematic cross-sectional view showing an entire structure of a vehicle air conditioner according to a sixth embodiment.

FIG. 17 is a schematic cross-sectional view showing an entire structure of a vehicle air conditioner according to a seventh embodiment.

FIG. 18 is a schematic cross-sectional view showing an entire structure of a vehicle air conditioner according to an eighth embodiment.

FIG. 19 is a schematic cross-sectional view showing an entire structure of a vehicle air conditioner according to a ninth embodiment.

FIG. 20 is a schematic cross-sectional view showing an entire structure of a vehicle air conditioner according to a tenth embodiment.

FIG. 21 is a cross-sectional view taken along the line XXI-XXI of FIG. 20.

### DESCRIPTION OF EMBODIMENTS

Embodiments of the present disclosure will be described below with reference to the accompanying drawings. In the following respective embodiments, the same or equivalent parts as the matters explained in the previous embodiment(s) are denoted by the same reference numerals, and the description thereof will be omitted in some cases. When only part of a component in each of the embodiments is explained, other parts of the component can be applied to components explained in the previous embodiment(s).

### First Embodiment

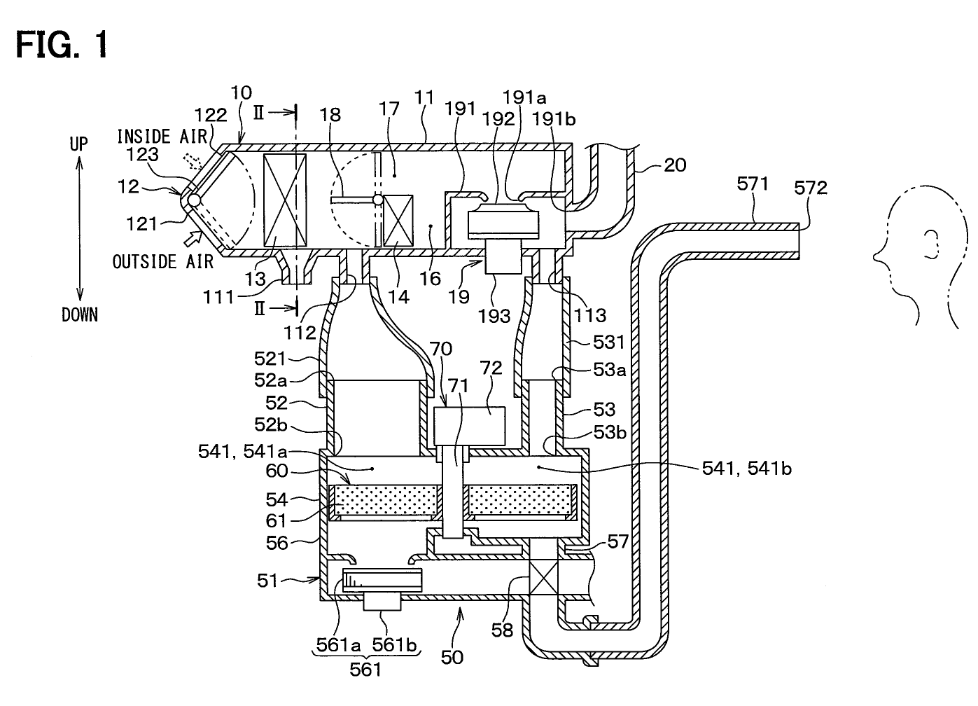

This embodiment will describe an example in which a vehicle air conditioner to perform air-conditioning of the vehicle interior is applied to a vehicle that obtains a driving force for vehicle traveling from an internal combustion engine (for example, engine) (not shown). As shown in FIG. 1, the vehicle air conditioner includes an air-conditioning unit 10 and a humidification device 50 as main components. Note that respective arrows indicating the upper and lower sides shown in FIG. 1 indicate the up and down directions when the vehicle air conditioner is mounted on the vehicle. The same goes for other drawings.

First, the air-conditioning unit 10 will be described. The air-conditioning unit 10 is disposed below a dashboard (i.e., an instrumental panel) in the vehicle interior. The air-conditioning unit 10 accommodates an evaporator 13 and a heater core 14 in an air-conditioning case 11 forming an outer shell of the air-conditioning unit.

The air-conditioning case 11 configures a ventilation passage through which the ventilation air is blown into the vehicle interior. The air-conditioning case 11 in this embodiment is formed of resin (for example, polypropylene) with some elasticity and excellent strength.

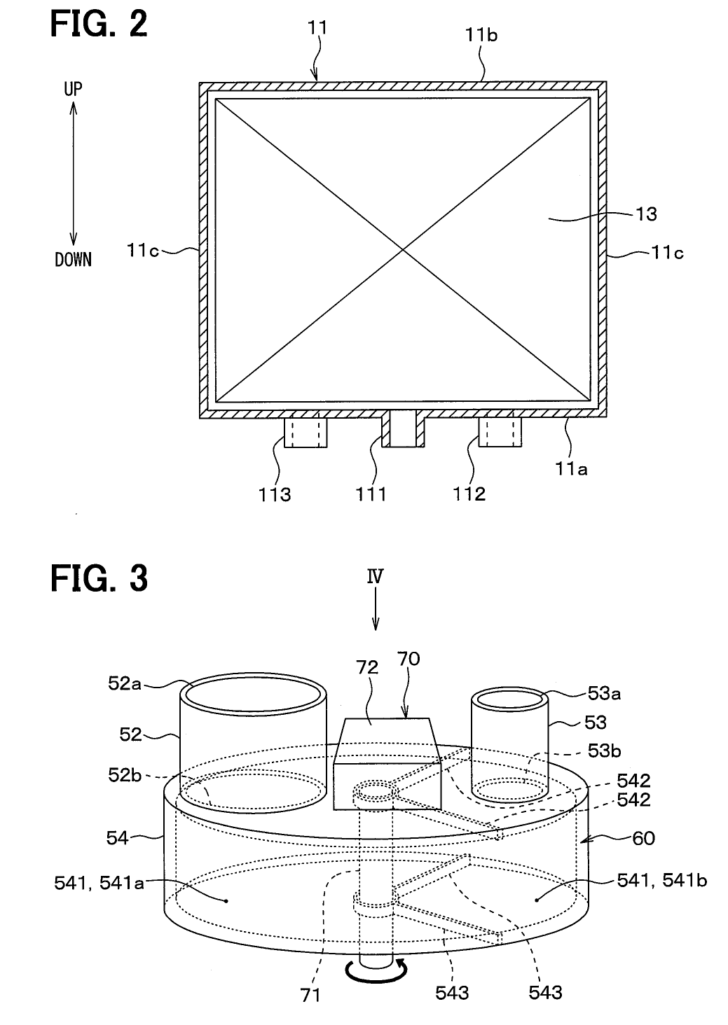

FIG. 2 shows a schematic cross-sectional view of the air-conditioning case 11 obtained when cutting the air-conditioning case 11 in a direction perpendicular to the air-flow direction. As shown in FIG. 2, in the air-conditioning case 11 of this embodiment, the ventilation passage through which the ventilation air flows is partitioned and formed by a bottom surface portion 11a, an upper surface portion 11b, and side surface portions 11c. Note that FIG. 2 illustrates an example in which a drain discharge portion 111, a cold-air guiding portion 112, and a hot-air guiding portion 113 to be described later are arranged in parallel in the right-left direction on a paper surface for the convenience of explanation, which obviously should not be construed in a limited sense.

The bottom surface portion 11a is a part configuring a lower-side wall surface that faces the bottoms of the evaporator 13, heater core 14, and the like in the air-conditioning case 11. The upper surface portion 11b is a part configuring an upper-side wall surface that faces the bottom surface portion 11a of the air-conditioning case 11. The side surface portions 11c are parts configuring wall surfaces of the air-conditioning case 11 other than the bottom surface portion 11a and the upper surface portion 11b. In practice, the cross section of the air-conditioning case 11 is not in a quadrilateral shape, such as that shown in FIG. 2, in some cases. When the bottom surface portion 11a and the like are difficult to distinguish clearly in this way, the bottom surface portion 11a can be interpreted as a part that occupies one third on the lower side of the cross section of the air-conditioning case 11. The upper surface portion 11b can be interpreted as a part that occupies one third on the upper side of the cross section of the air-conditioning case 11. The side surface portions 11c can be interpreted as a part that occupies one third at the center part of the cross section of the air-conditioning case 11.

Returning to FIG. 1, an inside/outside air switching box 12 is disposed at the most upstream side of the air flow in the air-conditioning case 11. The inside/outside air switching box serves to switch between air outside a vehicle compartment (i.e., the outside air) and air in the vehicle interior (i.e., the inside air) and to introduce the switched air into the air-conditioning case. The inside/outside air switching box 12 is provided with an outside-air introduction port 121 for introducing the outside air and an inside-air introduction port 122 for introducing the air of the vehicle interior. An inside/outside air switching door 123 is disposed within the inside/outside air switching box 12. The inside/outside air switching door 123 changes the ratio of the introduced volume of the outside air to the introduced volume of the inside air by adjusting opening areas of the respective introduction ports 121 and 122.

The inside/outside air switching door 123 is rotatably disposed between the outside-air introduction port 121 and the inside-air introduction port 122. The inside/outside air switching door 123 is driven by an actuator (not shown).

The evaporator 13 is disposed on the air-flow downstream side of the inside/outside air switching box 12. The evaporator 13 configures a cooling portion that cools the ventilation air to be blown into the vehicle interior. The evaporator 13 is a heat exchanger that absorbs, from the ventilation air, the latent heat of evaporation of a low-temperature refrigerant circulating therethrough, thereby cooling the ventilation air. The evaporator 13 configures a vapor compression refrigeration cycle together with a compressor, a condenser, and a decompression mechanism (all not shown). _p A hot-air passage 16 and a cold-air bypass passage 17 are formed on the air-flow downstream side of the evaporator 13. The hot-air passage 16 allows the air cooled by the evaporator 13 to flow to the side of the heater core 14. The cold-air bypass passage 17 allows the air cooled by the evaporator 13 to flow bypassing the heater core 14.

The heater core 14 is a heat exchanger that heats the ventilation air by using a coolant for an engine (not shown) as a heat source. In this embodiment, the heater core 14 configures a heating portion that heats the ventilation air.

An air mix door 18 is rotatably disposed between the evaporator 13 and the heater core 14. The air mix door 18 is a member that is driven by an actuator (not shown) and regulates the temperature of the ventilation air to be blown into the vehicle interior by adjusting the ratio of the air circulating through the hot-air passage 16 to the air circulating through the cold-air bypass passage 17.

An air-conditioning blower 19 is disposed on the air-flow downstream side of the hot-air passage 16 and the cold-air bypass passage 17. The air-conditioning blower 19 is a device that generates an air flow within the air-conditioning case 11, to be blown into the vehicle interior. The air-conditioning blower 19 includes a blowing case 191, an air-conditioning fan 192, and an air-conditioning motor 193.

The blowing case 191 configures a part of the air-conditioning case 11. The blowing case 191 is provided with a suction port 191a for air and a discharge port 191b from which the air drawn via the suction port 191a is discharged.

The air-conditioning fan 192 draws the air on the air-flow downstream side of the hot-air passage 16 and cold-air bypass passage 17 via the suction port 191a and discharges the air from the discharge port 191b. The air-conditioning fan 192 in this embodiment is configured of a centrifugal fan that blows the air drawn thereinto from the axial direction toward the outside thereof in the radial direction. The air-conditioning fan 192 is rotatably driven by the air-conditioning motor 193. Note that the air-conditioning fan 192 is not limited to the centrifugal fan and may be configured of an axial fan, a cross flow fan, or the like.

The discharge port 191b of the air-conditioning blower 19 is connected to an air-conditioning duct 20. The air-conditioning duct 20 is a member that is opened within the vehicle interior and guides the ventilation air to outlet portions (not shown) to blow the air therefrom into the vehicle interior. Although not shown, the outlet portions include a face air outlet that blows air toward a side of an occupant's upper body, a foot air outlet that blows air toward a side of the occupant's lower body, and a defroster air outlet that blows air toward a windshield of the vehicle. The air-conditioning duct 20 or blowing case 191 is provided with a mode switching door (not shown) that sets a blowing mode of the air from each air outlet. The mode switching door is driven by an actuator (not shown).

The air-conditioning case 11 in this embodiment has the drain discharge portion 111, the cold-air guiding portion 112, and the hot-air guiding portion 113, which are formed on its bottom surface portion 11a. The drain discharge portion 111 is an opening from which the condensed water generated in the evaporator 13 is discharged toward the outside of the vehicle. The drain discharge portion 111 in this embodiment is formed at a part of the bottom surface portion 11a of the air-conditioning case 11 that faces a lower end of the evaporator 13.

The cold-air guiding portion 112 is an opening through which part of the ventilation air (i.e., cooled air) cooled by the evaporator 13 in the air-conditioning case 11 is guided toward the outside of the air-conditioning case 11. The cold-air guiding portion 112 in this embodiment is formed at a part between the evaporator 13 and the heater core 14 at the bottom surface portion 11a of the air-conditioning case 11. More specifically, the cold-air guiding portion 112 is formed at the bottom surface portion 11 a positioned between the drain discharge portion 111 and the heater core 14.

The hot-air guiding portion 113 is an opening through which part of the ventilation air (i.e., heated air) heated by the heater core 14 in the air-conditioning case 11 is guided toward the outside of the air-conditioning case 11. The hot-air guiding portion 113 in this embodiment is formed between the air-conditioning fan 192 and the discharge port 191b of the air-conditioning blower 19, at the bottom surface portion 11a of the air-conditioning case 11. The position where the hot-air guiding portion 113 in this embodiment is formed only needs to be on the air-flow downstream side of the air-conditioning blower 19, for example, may be in the air-conditioning duct 20 of the air-conditioning case 11.

The air-conditioning unit 10 in this embodiment adopts a so-called suction type structure in which the air-conditioning blower 19 is disposed on the air-flow downstream side in the air-conditioning case 11. Thus, the internal pressure of the air-conditioning case 11 is lower than the pressure outside the air-conditioning case 11.

Subsequently, the humidification device 50 will be described. The humidification device 50 is disposed below the dashboard of the vehicle, like the air-conditioning unit 10. More specifically, the humidification device 50 is disposed on the lower side of the air-conditioning case 11 and in a position close to a part of the air-conditioning case 11 where the evaporator 13 is disposed, in such a manner as to make the cold-air guiding portion 112 of the air-conditioning case 11 close to a cold-air suction portion 52 of the humidification device 50 to be described later.

The humidification device 50 accommodates an adsorber 60 in an adsorption case 51 forming an outer shell of the humidification device. The adsorption case 51 configures a ventilation passage for the ventilation air. The adsorption case 51 is a component separately formed from the air-conditioning case 11. The adsorption case 51 is mainly divided into the cold-air suction portion 52, a hot-air suction portion 53, an adsorber accommodating portion 54, a cold-air discharge portion 56, and a hot-air discharge portion 57.

The cold-air suction portion 52 includes a first external introduction port 52a communicating with the outside thereof, and a first internal communication port 52b communicating with a moisture-adsorption space 541a of the adsorber accommodating portion 54 to be described later. The first external introduction port 52a is connected to a cold-air suction duct 521 for introduction of the cooled air produced by the evaporator 13.

The cold-air suction duct 521 connects the first external introduction port 52a of the cold-air suction portion 52 with the cold-air guiding portion 112 of the air-conditioning case 11. The cold-air suction duct 521 in this embodiment configures a first introduction portion that introduces the cooled air produced by the evaporator 13 into a moisture-adsorption space 541a of the adsorber accommodating portion 54, as described later. The cold-air suction duct 521 is a component separately formed from the air-conditioning case 11 and configured to be detachable from the cold-air guiding portion 112 by a coupling member (not shown), such as a snap-fit.

The hot-air suction portion 53 includes a second external introduction port 53a communicating with the outside thereof, and a second internal communication port 53b communicating with a moisture-desorption space 541b of the adsorber accommodating portion 54 to be described later. The second external introduction port 53a is connected to a hot-air suction duct 531 for introduction of the heated air produced by the heater core 14.

The hot-air suction duct 531 connects the second external introduction port 53a of the hot-air suction portion 53 with the hot-air guiding portion 113 of the air-conditioning case 11. The hot-air suction duct 531 in this embodiment configures a second introduction portion that introduces the heated air, produced by the heater core 14, into a moisture-desorption space 541b of an adsorber accommodating portion 54, as described later. The hot-air suction duct 531 is a component separately formed from the air-conditioning case 11 and configured to be detachable from the hot-air guiding portion 113 by a coupling member (not shown), such as a snap-fit.

The hot-air suction duct 531 in this embodiment has its size set such that when a reference air volume is defined as a minimum air volume from the air-conditioning blower 19, the air volume of the heated air introduced via the hot-air suction duct 531 is smaller (for example, at 10 m³/h, which is approximately 10% of the reference air volume) than the reference air volume. In this case, the heated air introduced via the hot-air suction duct 531 is sufficiently smaller than the reference air volume, which hardly affects an air-conditioning function of the side of the air-conditioning unit 10.

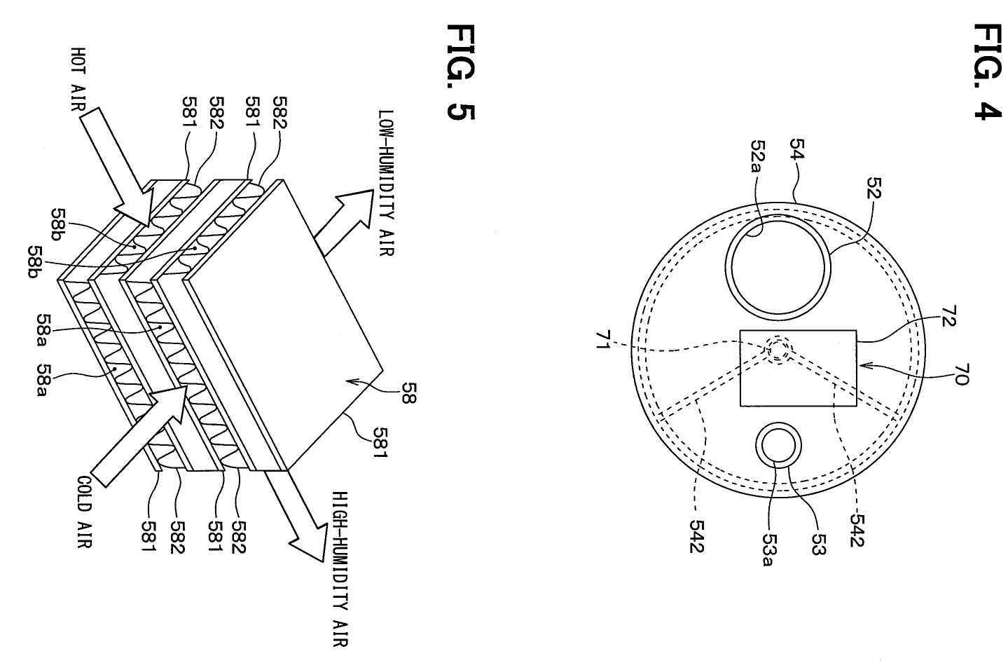

The adsorber accommodating portion 54 is a part that accommodates the adsorber 60 therein. As shown in FIGS. 3 and 4, the adsorber accommodating portion 54 in this embodiment has a hollow cylindrical contour. The adsorber accommodating portion 54 has an accommodating space 541 for the adsorber 60 formed therein.

The adsorber accommodating portion 54 sets, as the accommodating space 541, a space for circulation of the cooled air introduced via the cold-air suction portion 52 and a space for circulation of the heated air introduced via the hot-air suction portion 53.

Specifically, the accommodating space 541 is partitioned into the space for circulation of the cooled air and the space for circulation of the heated air by first and second partition members 542 and 543 that are provided on both the air-flow upstream and downstream sides of the adsorber 60.

The first partition member 542 is a member that is provided on the air-flow upstream side of the adsorber 60 and partitions the space on the air-flow upstream side of the adsorber 60 into a flow path for the cooled air and a flow path for the heated air. The first partition member 542 is integral with the inner side of an upper surface part of the adsorber accommodating portion 54.

The second partition member 543 is a member that is provided on the air-flow downstream side of the adsorber 60 and partitions the space on the air-flow downstream side of the adsorber 60 into the flow path for the cooled air and the flow path for the heated air. The second partition member 543 is integral with the inner side of a bottom surface part of the adsorber accommodating portion 54.

In the adsorber accommodating portion 54, the adsorber 60 is disposed to stride across both the space for circulation of the cooled air and the space for circulation of the heated air. The space for circulation of the cooled air in the adsorber accommodating portion 54 configures the moisture-adsorption space 541a that allows moisture contained in the cooled air to be adsorbed in the adsorbent 61 of the adsorber 60. The space for circulation of the heated air in the adsorber accommodating portion 54 configures the moisture-desorption space 541b that desorbs moisture adsorbed in the adsorbent 61 of the adsorber 60 therefrom and humidifies the heated air with the moisture.

An adsorption rate of moisture per unit mass into the adsorbent 61 tends to be approximately twice as slow as a desorption rate of moisture per unit mass from the adsorbent 61. As the amount of the moisture adsorbed into the adsorbent 61 decreases, the amount of the moisture desorbed from the adsorbent 61 becomes less. Consequently, it might be difficult for the humidification device to sufficiently ensure the humidification amount of the vehicle interior.

When taking this into account, in this embodiment, the accommodating space 541 of the adsorber 60 is partitioned by the respective partition members 542 and 543 such that the amount of the adsorbent 61 existing in the moisture-adsorption space 541a is more than that of the adsorbent existing in the moisture-desorption space 541b. Specifically, a member bent in a L shape is used as each of the partition members 542 and 543, and thereby the moisture-adsorption space 541a is set approximately twice as large as the moisture-desorption space 541b in the accommodating space 541 of the adsorber 60. Note that the details of the adsorber 60 will be described later.

Returning to FIG. 1, the cold-air discharge portion 56 is a part that communicates with the moisture-adsorption space 541a of the adsorber accommodating portion 54 and discharges the air passing through the moisture-adsorption space 541a to the outside of the adsorption case 51. The cold-air discharge portion 56 in this embodiment is connected to a cold-air discharge duct (not shown).

The cold-air discharge duct is a duct that guides out the air passing through the moisture-adsorption space 541a of the adsorption case 51 to the outside of the adsorption case 51. The cold-air discharge duct configures a moisture-adsorption side guiding portion. The cold-air discharge duct has an outlet opening at its downstream-side end that is opened to the inside of the dashboard. In this way, the cold air flowing through the cold-air discharge duct is blown into the internal space of the dashboard.

A humidification blower 561 is disposed in the cold-air discharge portion 56 in this embodiment. The humidification blower 561 is provided to introduce the cooled air into the adsorption case 51 from the inside of the air-conditioning case 11 having a lower pressure, compared to the external pressure. The humidification blower 561 includes a humidification fan 561a, a humidification motor 561b, and the like.

The humidification fan 561a draws the air from the moisture-adsorption space 541a of the adsorber accommodating portion 54 and discharges the air therefrom. The humidification fan 561a in this embodiment is configured of a centrifugal fan that blows the air drawn thereinto from the axial direction toward the outside thereof in the radial direction. The humidification fan 561a is rotatably driven by the humidification motor 561b. Note that the humidification fan 561a is not limited to the centrifugal fan and may be configured of an axial fan, a cross flow fan, or the like.

The hot-air discharge portion 57 is a part that communicates with the moisture-desorption space 541b of the adsorption case 51 and discharges the air passing through the moisture-desorption space 541b to the outside of the adsorption case 51. The hot-air discharge portion 57 in this embodiment is connected to a humidification duct 571.

The humidification duct 571 configures a humidification-side guiding portion that guides out the humidification air, humidified in the moisture-desorption space 541b of the adsorption case 51, into the vehicle interior. The humidification duct 571 in this embodiment is a component separately formed from the air-conditioning duct 20, which is an outlet duct in the air-conditioning unit 10.

In the humidification duct 571, an outlet opening 572 as its downstream end is opened at a part (for example, a meter hood) located at the dashboard and near an occupant's face. The outlet opening 572 is opened in a position different from the outlet portion of the air-conditioning unit 10. Thus, the air flowing through the humidification duct is blown toward the occupant's face, thereby humidifying a space around the occupant's face.

In this embodiment, a duct having a flow-path diameter of φ50 mm and a flow-path length of approximately 1000 mm is adopted as the humidification duct 571. Thus, the high-temperature and high-humidity humidification air having passed through the adsorber 60 is cooled by exchanging heat with the air outside the humidification duct 571, thereby making it possible to increase the relative humidity of the humidification air.

Regarding the outlet opening 572 of the humidification duct 571, its opening diameter and its distance to the occupant's face are set such that the blown air therefrom reaches the face in a high-humidity state. The outlet opening 572 in this embodiment is set to have an opening diameter of approximately 75 mm and a distance to the occupant's face of approximately 600 mm in such a manner that the air reaching the face is at a relative humidity of approximately 40%, a temperature of approximately 20° C., and an air speed of approximately 0.5 m/s. That is, in this embodiment, the humidification duct 571 in use is a duct in which an opening area of the outlet opening 572 is larger than a flow-path cross section of the flow path leading to the outlet opening 572. In the humidification duct 571 configured in this way, the air speed reaching the occupant becomes low, so that the diffusion of the humidification air can be suppressed, thereby surely causing the humidification air to reach the face.

Furthermore, the humidification duct 571 in this embodiment is configured to be thinner than the cold-air suction duct 521 and the hot-air suction duct 531 in such a manner as to exchange heat between the air circulating through the duct 571 and the air existing outside the duct 571.

A gas-gas heat exchanger 58 is disposed in the cold-air discharge portion 56 and hot-air discharge portion 57 in this embodiment. The gas-gas heat exchanger 58 exchanges heat between the air (i.e., cold air) passing through the moisture-adsorption space 541a of the adsorber accommodating portion 54 and the air (i.e., hot air) passing through the moisture-desorption space 541b.

As shown in FIG. 5, the gas-gas heat exchanger 58 is a heat exchanger that includes a plurality of metal plate-shaped members 581 and fins 582 disposed between the adjacent plate-shaped members 581. The gas-gas heat exchanger 58 in this embodiment independently forms flow paths 58a for circulation of the cold air and flow paths 58b for circulation of the hot air so as not to mix the cold air and hot air therein. Note that materials for use in the plate shaped members 581 and the fins 582 are desirably formed of metal with excellent heat conductivity (e.g., aluminum, or copper).

Subsequently, the adsorber 60 will be described with reference to FIGS. 3 and 4. As shown in FIGS. 3 and 4, the adsorber 60 has a disk-shaped contour that corresponds to the inner shape of the adsorber accommodating portion 54. The adsorber 60 has its center part coupled to a rotary shaft 71 of a driving member 70 to be described later. The adsorber 60 is rotatably supported by the adsorption case 51 via the rotary shaft 71.

The adsorber 60 is configured to support the adsorbent 61 that adsorbs and desorbs (or releases) moisture into and from the metal plate-shaped members (not shown). The respective plate-shaped members are stacked on each other with a spacing therebeween so as to form a flow path between the adjacent plate-shaped members along the axial direction of the rotary shaft 71 to be described later. The adsorber 60 in this embodiment increases a contact area between the ventilation air and the adsorbent 61 by stacking the respective plate-shaped members that support the adsorbent 61.

The adsorbent 61 adopts a polymer sorbent. The adsorbent 61 preferably has adsorption property that changes the moisture amount adsorbed (i.e., the adsorption amount) by at least 3 wt % or more when changing the relative humidity of the ventilation air passing through the adsorber 60 by 50% within a temperature range expected as a temperature of the ventilation air. More preferably, the adsorbent 61 has the adsorption property that changes the adsorption amount thereof within a range of 3 wt % to 10 wt % under an environment on the same conditions as those described above.

The adsorber 60 in this embodiment is accommodated in the adsorber accommodating portion 54 that has its internal space partitioned into the moisture-adsorption space 541a and the moisture-desorption space 541b. Although the adsorber 60 is disposed to stride across both the moisture-adsorption space 541a and the moisture-desorption space 541b as mentioned above, there is a limitation on the adsorption amount of moisture that can be adsorbed in the adsorbent 61 existing in the moisture-adsorption space. Further, there is also a limitation on the amount of moisture desorbed by the adsorbent 61 existing in the moisture-desorption space 541b.

The humidification device 50 is provided with the driving member 70 that serves as a movement mechanism for moving the adsorbent 61 of the adsorber 60 between the moisture-adsorption space 541a and the moisture-desorption space 541b. The driving member 70 is a device that moves at least a part of the adsorbent 61 existing in the moisture-adsorption space 541a of the adsorber 60 to the moisture-desorption space 541b, while moving at least a part of the adsorbent 61 existing in the moisture-desorption space 541b of the adsorber 60 to the moisture-adsorption space 541a.

The driving member 70 is configured to include the rotary shaft 71 and an electric motor 72 with a decelerator. The rotary shaft 71 is coupled to the adsorber 60, while penetrating the center of the adsorber 60. The electric motor 72 serves to rotatably drive the rotary shaft 71. The rotary shaft 71 is rotatably supported by the adsorption case 51. The rotary shaft 71 rotates together with the adsorber 60 within the adsorption case 51 when receiving a driving force transferred thereto from the electric motor 72. Thus, a part of the adsorbent 61 existing in the moisture-desorption space 541b of the adsorber 60 moves to the moisture-adsorption space 541a, while a part of the adsorbent 61 existing in the moisture-adsorption space 541a of the adsorber 60 moves to the moisture-desorption space 541b.

The electric motor 72 in this embodiment serves to rotatably drive the rotary shaft 71 continuously in one direction. Thus, the adsorbent 61 that has sufficiently desorbed moisture at the moisture-desorption space 541b in the adsorber 60 can be moved to the moisture-adsorption space 541a, while the adsorbent 61 that has sufficiently adsorbed moisture at the moisture-adsorption space 541a in the adsorber 60 can be moved to the moisture-desorption space 541b.

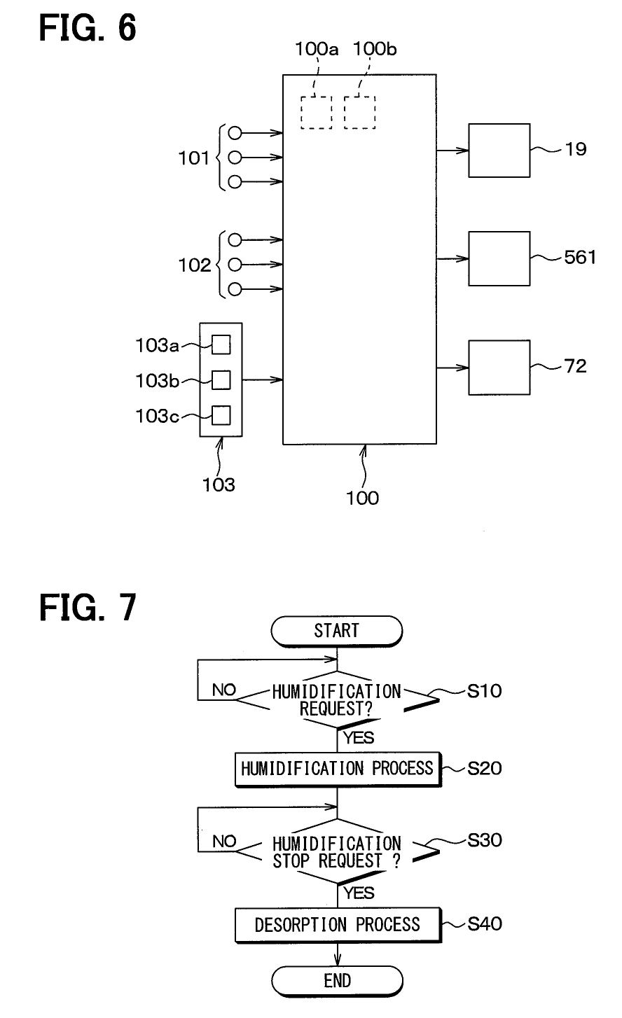

Next, a controller 100 serving as an electric control unit for the vehicle air conditioner will be described with reference to FIG. 6. The controller 100 shown in FIG. 6 is configured of a microcomputer, including storage units, such as a CPU, a ROM, and a RAM, and a peripheral circuit thereof. The controller 100 performs various computations and processing based on control programs stored in the storage unit to thereby control the operations of various devices that are connected to its output side. Note that the storage unit in the controller 100 is configured of a non-transitional entity storage.

The controller 100 in this embodiment is a device obtained by integrally forming a control unit for controlling the operations of respective components of the air-conditioning unit 10 and a control unit for controlling the operations of respective components of the humidification device 50. Alternatively, the controller 100 may have a structure that separately includes the control unit for controlling the operations of respective components of the air-conditioning unit 10 and the control unit for controlling the operations of respective components of the humidification device 50.

The input side of the controller 100 is connected to a group 101 of various sensors for air-conditioning control, a group 102 of various sensors for humidification control, and an operation panel 103 for the air-conditioning control and the humidification control.

The group 101 of various sensors for air-conditioning control includes: an inside-air temperature sensor that detects an inside-air temperature; an outside-air temperature sensor that detects an outside-air temperature; a solar radiation sensor that detects the amount of solar radiation in the vehicle interior; and an evaporator temperature sensor that detects the temperature of the evaporator 13.

The group 102 of various sensors for the humidification control includes a first temperature sensor that detects the temperature of air blown from the humidification duct 571 and a second temperature sensor that detects the temperature of air blown from the cold-air discharge duct.

The operation panel 103 is provided with an air-conditioning operation switch 103a, a humidification operation switch 103b, a temperature setting switch 103c, and the like. The air-conditioning operation switch 103a is a switch that switches between on and off of an air-conditioning operation by the air-conditioning unit 10. The humidification operation switch 103b is a switch that switches between on and off of a humidification operation of the humidification device 50. The temperature setting switch 103c is a switch that presets a target temperature of air blown out of the air-conditioning unit 10 or the humidification device 50.

The controller 100 in this embodiment is a device that integrates therein hardware and software of the control units for controlling the operations of various components connected to its output side. The control units integrated in the controller 100 include a humidification control unit 100a and a desorption control unit 100b. The humidification control unit 100a executes a humidification operation for humidifying the vehicle interior by the humidification device 50. The desorption control unit 100b executes a desorption operation for desorbing moisture, adsorbed in the adsorbent 61, when stopping the humidification of the vehicle interior.

Next, the operations of the air-conditioning unit 10 and the humidification device 50 in this embodiment will be described. First, the outline of the operation of the air-conditioning unit 10 will be described. In the air-conditioning unit 10, when the air-conditioning operation switch 103a is turned on, the controller 100 calculates a target air outlet temperature TAO of the ventilation air to be blown into the vehicle interior, based on detection signals from the group 101 of the respective sensors for the air-conditioning control and the preset temperature set by the temperature setting switch 103c. The controller 100 controls the operations of the respective components in the air-conditioning unit 10 such that the temperature of the ventilation air to be blown into the vehicle interior approaches the target air outlet temperature TAO.

In this way, the controller 100 in the air-conditioning unit 10 controls the respective components according to the detection signals or the like from the group 101 of the respective sensors for the air-conditioning control, thereby making it possible to achieve the appropriate temperature adjustment of the vehicle interior requested by the user.

Subsequently, the operation of the humidification device 50 will be described below with reference to the flowchart of FIG. 7. The controller 100 executes control processing when the air-conditioning operation switch 103a is turned on as shown in the flowchart of FIG. 7.

As shown in FIG. 7, the controller 100 determines whether a humidification request is made or not by detecting on or off of the humidification operation switch 103b (S10). In the determination process at step S10, the humidification request is determined not to be made when the humidification operation switch 103b is turned off, whereas the humidification request is determined to be made when the humidification operation switch 103b is turned on.

When the humidification request is determined to be made as a result of the determination process at step S10, the controller 100 executes the humidification operation of the vehicle interior by using the humidification device 50 (S20). Specifically, the controller 100 operates the driving member 70 while operating the humidification blower 561, thereby rotating the adsorber 60 at a predetermined rotational speed (for example, 5 rpm). Note that when the air mix door 18 is located in a position that closes the hot-air passage 16, the controller 100 causes the air mix door 18 to be displaced to a position that opens the hot-air passage 16 (for example, an intermediate position).

At this time, the controller 100 controls the humidification blower 561 such that when the reference air volume is defined as the minimum air volume from the air-conditioning blower 19, the air volume of the cooled air introduced via the cold-air suction duct 521 is smaller (for example, at 20 m³/h, which is approximately 20% of the reference air volume) than the reference air volume. In this case, the cooled air introduced via the cold-air suction duct 521 is sufficiently smaller than the reference air volume, which hardly affects an air-conditioning function of the side of the air-conditioning unit 10. Note that the controller 100 may be adapted to control the air volume of the air-conditioning blower 19 based on the detection values and the like from the group 102 of the respective sensors for the humidification control.

The controller 100 controls the electric motor 72 of the driving member 70 in such a manner that the adsorbent 61, which has sufficiently desorbed moisture in the moisture-desorption space 541b, moves to the moisture-adsorption space 541a of the adsorber accommodating portion 54. For example, the controller 100 controls the electric motor 72 such that when a reference time is defined as a time required to desorb moisture from the adsorbent 61 in the moisture-desorption space 541b, the adsorbent 61 is moved to the moisture-adsorption space 541a after the reference time has elapsed since the movement of the adsorbent 61 to the moisture-desorption space 541b.

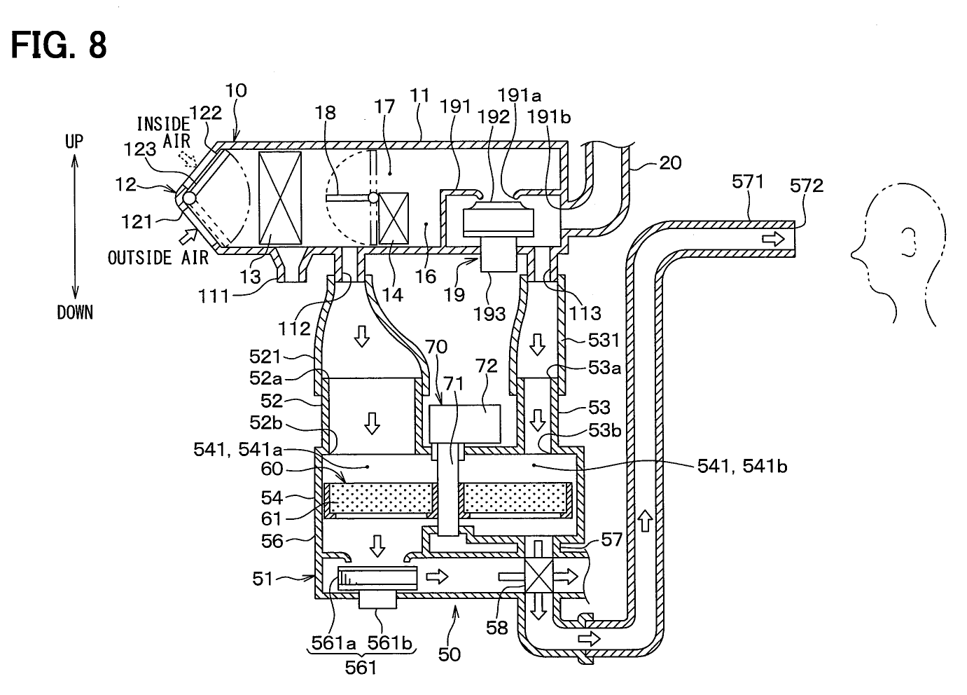

Here, a description will be given on the operating state of the humidification device 50 when the controller 100 executes the humidification operation with reference to FIG. 8. As shown in FIG. 8, part of the low-temperature and high-humidity cooled air (for example, at a temperature of 5° C. and a relative humidity of 70%), cooled by the evaporator 13, is introduced into the adsorption case 51 via the cold-air suction duct 521. The moisture contained in the cooled air introduced into the adsorption case 51 is adsorbed into the adsorbent 61 existing in the moisture-adsorption space 541a of the adsorber 60.

At this time, since the adsorber 60 rotates within the accommodating space 541, the adsorbent 61, which has sufficiently desorbed moisture in the moisture-desorption space 541b of the adsorber 60, moves to the moisture-adsorption space 541a. Thus, the moisture contained in the cooled air introduced into the adsorption case 51 is continuously adsorbed into the adsorbent 61 existing in the moisture-adsorption space 541a of the adsorber 60.

Subsequently, the air passing through the moisture-adsorption space 541a flows to the cold-air discharge duct via the cold-air discharge portion 56 and is then blown into the internal space of the dashboard. Thus, the cold air at a low humidity hardly flows into the vehicle interior.

Part of the high-temperature and low-humidity heated air (for example, at a temperature of 25° C. and a relative humidity of 20%), heated by the heater core 14, is introduced into the adsorption case 51 via the hot-air suction duct 531. Moisture adsorbed in the adsorbent 61 is desorbed therefrom within the moisture-desorption space 541b in the adsorber 60, and then the heated air introduced into the adsorption case 51 is humidified (for example, at a temperature of 21° C. and a relative humidity of 57%) with the desorbed moisture.

At this time, since the adsorber 60 rotates within the accommodating space 541, the adsorbent 61, which has sufficiently adsorbed moisture in the moisture-adsorption space 541a of the adsorber 60, moves to the moisture-desorption space 541b. Thus, the heated air introduced into the adsorption case 51 is continuously humidified by the moisture desorbed from the adsorbent 61 existing in the moisture-adsorption space 541a of the adsorber 60.

In this embodiment, the hot-air suction duct 531 is connected to an air-discharge side of the air-conditioning blower 19 that becomes at a higher pressure than the pressure in the adsorption case 51. Thus, heated air produced by the heater core 14 is introduced into the adsorption case 51 via the hot-air suction duct 531 by a difference in pressure between the air-discharge side of the air-conditioning blower 19 and the adsorption case 51.

Subsequently, the humidification air, humidified in the moisture-desorption space 541b, flows through the hot-air discharge portion 57.

The humidification air flowing through the hot-air discharge portion 57 exchanges heat with the cooled air flowing through the cold-air discharge portion 56 in the gas-gas heat exchanger 58, and thereby the air is cooled and decreases its temperature while increasing its relative humidity (for example, at a temperature of 18° C. and a relative humidity of 65%). The humidification air having passed through the gas-gas heat exchanger 58 is blown from the outlet opening 572 toward the occupant's face via the humidification duct 571.

Returning to FIG. 7, the controller 100 determines whether a humidification stop request is made or not during execution of the above-mentioned humidification operation (S30). In the determination process at step S30, the humidification stop request is determined not to be made when each of the operation switches 103a and 103b is turned on, whereas the humidification stop request is determined to be made when either of the operation switches 103a and 103b is turned off.

When the humidification stop request is determined not to be made as a result of the determination process at step S30, the controller 100 continues the humidification operation.

On the other hand, when the humidification stop request is determined to be made as a result of the determination process at step S30, the controller 100 executes the desorption operation of desorbing moisture adsorbed in the adsorbent 61 of the adsorber 60 (S40).

Specifically, the controller 100 stops the operation of the humidification blower 561 while rotating the adsorber 60 by the driving member 70 during execution of the desorption operation.

Thus, the low-temperature and high-humidity cooled air produced by the evaporator 13 does not flow into the adsorption case 51 by stopping of the operation of the humidification blower 561, thereby stopping the adsorption of moisture in the adsorbent 61 existing in the moisture-adsorption space 541a of the adsorber 60.

On the other hand, the heated air at a high temperature and a low humidity, produced by the heater core 14, is introduced into the adsorption case 51 via the hot-air suction duct 531, and the moisture adsorbed in the adsorbent 61 existing in the moisture-desorption space 541b of the adsorber 60 is desorbed from the adsorbent 61.

In this way, the adsorption of the moisture in the adsorbent 61 of the moisture-adsorption space 541a is stopped, and the desorption of the moisture from the adsorbent 61 in the moisture-desorption space 541b is continued, so that the moisture adsorbed in the adsorbent 61 can be desorbed therefrom.

The controller 100 continues the desorption operation until a preset operation duration has elapsed. After the time has elapsed since the start of the desorption operation, the controller 100 stops the operations of the respective components of the humidification device 50 and ends the control processing. Note that the operation duration only needs to be set at a time required to cause the humidification device 50 to desorb the whole moisture adsorbed in the adsorbent 61 existing in the moisture-desorption space 541b.

The humidification device 50 in this embodiment described above and the vehicle air conditioner including the humidification device 50 can use the moisture of the cooled air produced by the air-conditioning unit 10 to humidify the vehicle interior, which eliminates the need to supply water from the outside to the vehicle air conditioner. Note that this embodiment utilizes the heated air produced by the air-conditioning unit 10 and thereby does not need to prepare a heat source dedicated to the humidification.

The humidification device 50 in this embodiment includes the driving member 70. The driving member 70 moves a part of the adsorbent 61 existing in the moisture-adsorption space 541a of the adsorber 60 to the moisture-desorption space 541b, while moving a part of the adsorbent 61 existing in the moisture-desorption space 541b of the adsorber 60 to the moisture-adsorption space 541a.

Thus, the moisture adsorbed into the adsorbent 61 in the moisture-adsorption space 541a can be desorbed from the adsorbent in the moisture-desorption space 541b, thereby humidifying the heated air with the moisture. Concurrently, the adsorbent 61 desorbing the moisture in the moisture-desorption space 541b can adsorb the moisture of the cooled air circulating through the moisture-adsorption space 541a.

Therefore, the humidification device 50 and the vehicle air conditioner in this embodiment can achieve the continuous humidification of the vehicle interior without being supplied with water.

In the humidification device 50 of this embodiment, the humidification duct 571 configuring a humidification-side guiding portion is a component separately formed from the air-conditioning duct 20 for the air having its temperature adjusted in the air-conditioning unit 10. Thus, the air having its temperature adjusted in the air-conditioning unit 10 is less likely to be mixed with the humidification air, humidified by the humidification device 50, so that the humidified air at a high humidity can be supplied to the vehicle interior.

Furthermore, in this embodiment, the adsorption case 51, the cold-air suction duct 521, and the hot-air suction duct 531 are components separately formed from the air-conditioning case 11. The cold-air suction duct 521 and the hot-air suction duct 531 are configured to be detachable from the air-conditioning case 11.

Thus, the humidification device 50 can be additionally installed on the air-conditioning unit 10. That is, the humidification device 50 can be used as an option (i.e., add-on parts) for the vehicle air conditioner.

In addition, in this embodiment, the gas-gas heat exchanger 58 is provided to exchange heat between the cooled air passing through the moisture-adsorption space 541a and the humidification air passing through the moisture-desorption space 541b. Thus, the gas-gas heat exchanger 58 cools the air having passed through the moisture-desorption space 541b by using the air (i.e., cooled air) having passed through the moisture-adsorption space 541a, so that the humidification air guided out into the vehicle interior can have a high relative humidity. As a result, the comfort for the occupant can be improved because of the humidification of the vehicle interior.

In this embodiment, the controller 100 executes the desorption operation that desorbs moisture, adsorbed in the adsorbent 61, when stopping the humidification of the vehicle interior. Thus, breeding of germs in the presence of moisture remaining in the adsorbent 61 can be suppressed during stopping the humidification device 50, thereby ensuring the comfort for the occupant because of the humidification of the vehicle interior.

The adsorbent 61 tends to exhibit the feature that the adsorption rate of moisture per unit mass becomes slower than the desorption rate of moisture per unit mass.

When taking this into account, in this embodiment, the accommodating space within the adsorption case 51 is partitioned by the respective partition members 542 and 543 such that the amount of the adsorbent 61 existing in the moisture-adsorption space 541a is more than that of the adsorbent 61 existing in the moisture-desorption space 541b.

Since the adsorption amount of moisture into the adsorbent 61 can be sufficiently ensured in the moisture-adsorption space 541a, the moisture adsorbed by the adsorbent 61 is efficiently desorbed in the moisture-desorption space 541b, thereby making it possible to ensure the sufficient humidification amount.

Although in the description of this embodiment, the humidification device 50 is disposed under the air-conditioning unit 10 by way of example, the present disclosure is not limited thereto. For example, the humidification device 50 may be disposed above or beside the air-conditioning unit 10.

### Second Embodiment

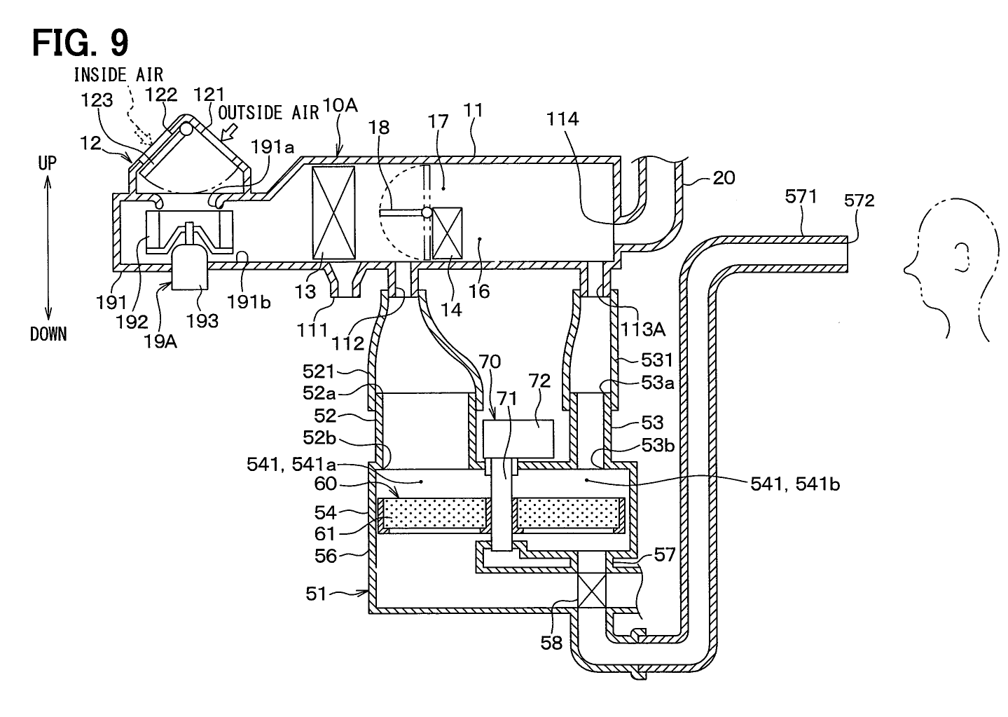

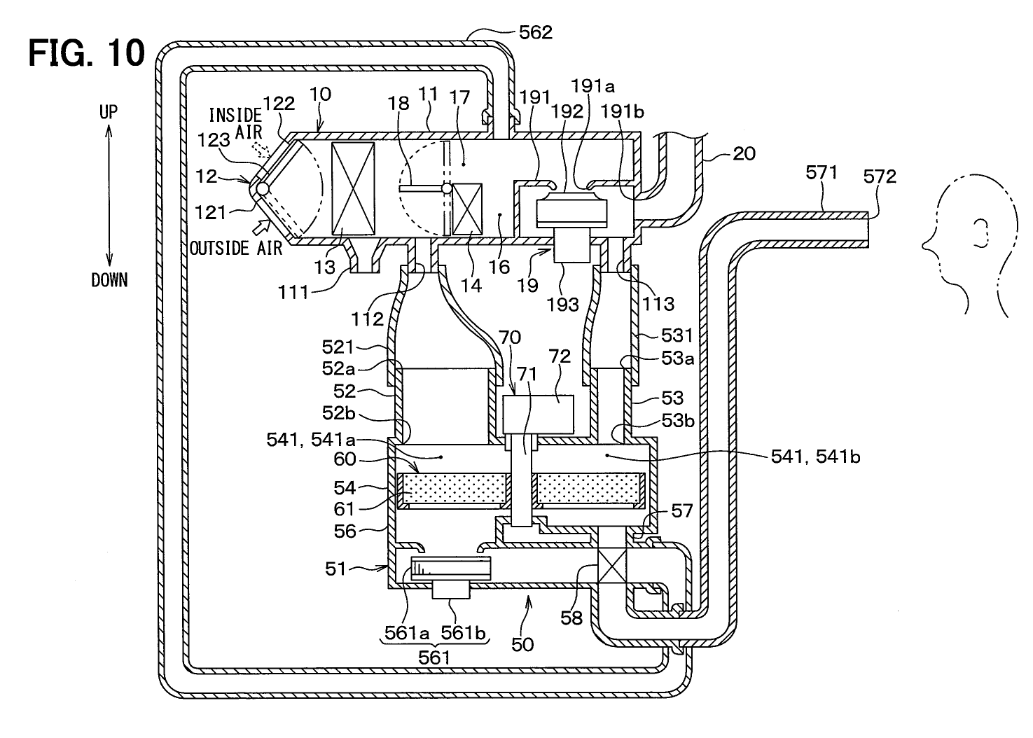

A second embodiment will be described with reference to FIG. 9. This embodiment differs from the first embodiment in that the humidification device 50 is applied to an air-conditioning unit 10A in which an air-conditioning blower 19A is disposed on the air-flow upstream side of the evaporator 13. In this embodiment, the description of the same or equivalent parts as those in the first embodiment will be omitted or simplified.

As shown in FIG. 9, in the air-conditioning unit 10A of this embodiment, the air-conditioning blower 19A is disposed on the air-flow downstream side of the inside/outside air switching box 12 and on the air-flow upstream side of the evaporator 13. In the air-conditioning blower 19A of this embodiment, the suction port 191a is opened toward the inside/outside air switching box 12, while the discharge port 191b is opened toward the evaporator 13.

The hot-air guiding portion 113A in this embodiment is formed on the air-flow downstream side of the heater core 14 at the bottom surface portion 11 a of the air-conditioning case 11. The hot-air guiding portion 113A in this embodiment only needs to be located on the air-flow downstream side of the heater core 14, for example, may be formed in the air-conditioning duct 20 of the air-conditioning case 11.

Furthermore, the air-conditioning case 11 in this embodiment has an opening 114 formed on the air-flow downstream side of the heater core 14. The opening 114 is to blow the temperature-adjusted air from the air-conditioning case 11 into the vehicle interior via the air-conditioning duct 20 and the outlet portions.

Other structures in the air-conditioning unit 10A are substantially the same as those in the first embodiment. The air-conditioning unit 10A in this embodiment adopts a so-called push-type structure in which the air-conditioning blower 19A is disposed on the air-flow upstream side of the evaporator 13. Thus, the pressure in the air-conditioning case 11, located after the discharge side of the air-conditioning blower 19A, is higher than the pressure outside the air-conditioning case 11.

Subsequently, the humidification device 50 in this embodiment will be described below. In the humidification device 50 of this embodiment, each of the suction ducts 521 and 531 is connected to the air-discharge side of the air-conditioning blower 19A that becomes at a higher pressure than the pressure in the adsorption case 51.

Thus, part of the cooled air produced by the evaporator 13 is introduced into the adsorption case 51 via the cold-air suction duct 521 by a difference in pressure between the air-discharge side of the air-conditioning blower 19 and the adsorption case 51. Likewise, part of the heated air produced by the heater core 14 is introduced into the adsorption case 51 via the hot-air suction duct 531.

In this embodiment, the cooled air and the heated air are introduced into the adsorption case 51 via the respective suction ducts 521 and 531, respectively, by a difference in pressure between the air-discharge side of the air-conditioning blower 19 and the adsorption case 51. Thus, the humidification device 50 in this embodiment eliminates a structure corresponding to the humidification blower 561 in the first embodiment.

The structures of other components in this embodiment are the same as those in the first embodiment. Also with the arrangement of this embodiment, the moisture of the cooled air produced by the air-conditioning unit 10A can be used to humidify the vehicle interior, which eliminates the need to supply water from the outside to the vehicle air conditioner. Thus, the moisture adsorbed into the adsorbent 61 in the moisture-adsorption space 541a can be desorbed from the adsorbent in the moisture-desorption space 541b, thereby humidifying the heated air with the moisture. Concurrently, the adsorbent 61 desorbing the moisture in the moisture-desorption space 541b can adsorb the moisture of the cooled air circulating through the moisture-adsorption space 541a.

Therefore, the humidification device 50 and the vehicle air conditioner in this embodiment can achieve the continuous humidification of the vehicle interior without being supplied with water.

In particular, the humidification device 50 in this embodiment eliminates the structure corresponding to the humidification blower 561 in the first embodiment. Thus, this embodiment has an advantage of enabling the reduction in the number of parts of the humidification device 50.

Like this embodiment, in the structure that introduces part of the cooled air produced by the evaporator 13 into the adsorption case 51 via the cold-air suction duct 521, the moisture in the adsorbent 61 is difficult to desorb sufficiently by the desorption operation when stopping the operation of the humidification device 50. For this reason, desirably, this embodiment additionally has an interruption member that temporarily interrupts the introduction of the cooled air produced by the evaporator 13 into the adsorption case 51. The interruption member may be configured, for example, of an opening/closing door that opens and closes the first external introduction port 52a.

### Third Embodiment

A third embodiment will be described with reference to FIG. 10. This embodiment differs from the first embodiment in that a discharge route for the air passing through the moisture-adsorption space 541a of the adsorption case 51 is modified. In this embodiment, the description of the same or equivalent parts as those in the first embodiment will be omitted or simplified.

As shown in FIG. 10, in this embodiment, an opening as the downstream-side end of a cold-air discharge duct 562 is connected to the air-conditioning case 11. The cold-air discharge duct 562 allows the air having passed through the moisture-adsorption space 541a to be discharged therefrom toward the outside. In this embodiment, the cold-air discharge duct 562 is connected to the air-conditioning case 11 such that the air flowing through the cold-air discharge duct 562 is returned to the cold-air bypass passage 17. A part of the connection of the cold-air discharge duct 562 is not limited thereto and can be connected to an arbitrary part of the air-conditioning case 11.

The structures of other components in this embodiment are the same as those in the first embodiment. Also with the arrangement of this embodiment, the moisture of the cooled air produced by the air-conditioning unit 10 can be used to humidify the vehicle interior, which eliminates the need to supply water from the outside to the vehicle air conditioner. Thus, the moisture adsorbed into the adsorbent 61 in the moisture-adsorption space 541a can be desorbed from the adsorbent in the moisture-desorption space 541b, thereby humidifying the heated air with the moisture. Concurrently, the adsorbent 61 desorbing the moisture in the moisture-desorption space 541b can adsorb the moisture of the cooled air circulating through the moisture-adsorption space 541a.

Therefore, the humidification device 50 and the vehicle air conditioner in this embodiment can achieve the continuous humidification of the vehicle interior without being supplied with water.

In particular, in the humidification device 50 of this embodiment, the downstream-side end of the cold-air discharge duct 562, which configures the moisture-adsorption side guiding portion, is connected to the air-conditioning case 11, and the cooled air passing through the moisture-adsorption space 541a is guided out into the air-conditioning case 11. Thus, the air having passed through the moisture-adsorption space 541a is returned into the air-conditioning case 11. This embodiment has an advantage of enabling the suppression of the leakage of low-humidity air into the vehicle interior.

### Fourth Embodiment

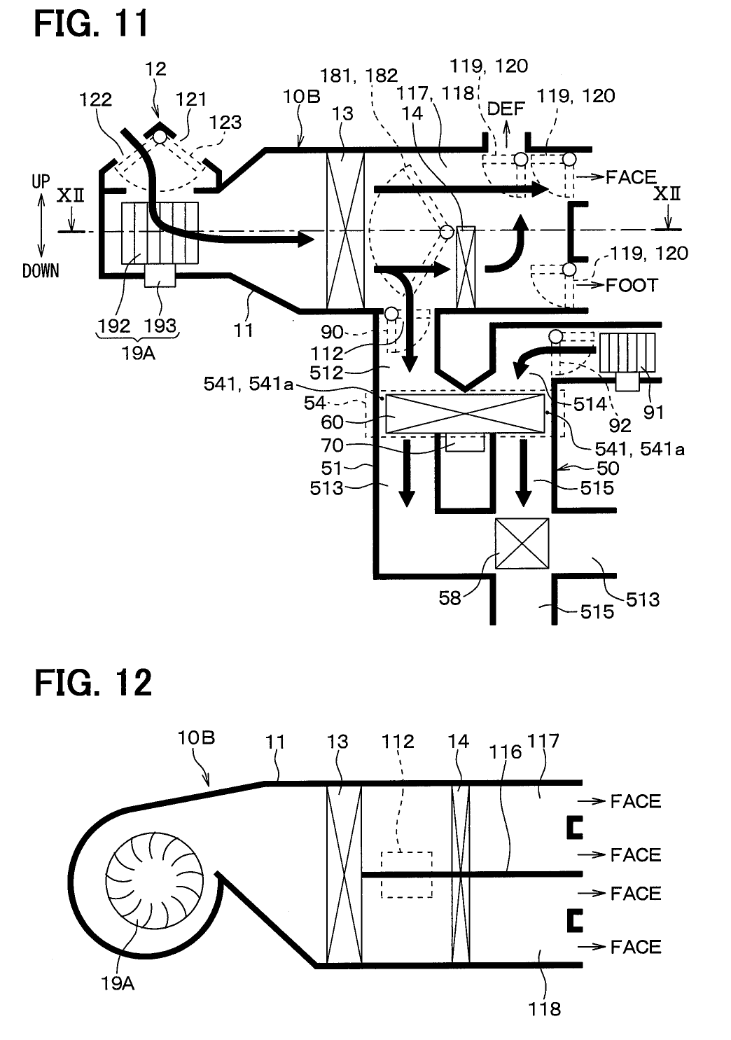

A fourth embodiment will be described with reference to FIGS. 11 and 12. This embodiment differs from the first to third embodiments in that the vehicle air conditioner is applied to an air-conditioning unit 10B capable of guiding ventilation air having the temperatures controlled independently to different sites of the vehicle interior. In this embodiment, the description of the same or equivalent parts as those in the first to third embodiments will be omitted or simplified.

As shown in FIGS. 11 and 12, in the air-conditioning case 11 of this embodiment, the air-conditioning blower 19A is disposed on the air-flow downstream side of the inside/outside air switching box 12. The air-conditioning blower 19A is a device that generates an air flow within the air-conditioning case 11, which is to be blown into the vehicle interior. The air-conditioning blower 19A includes an air-conditioning fan 192 and an air-conditioning motor 193 that drives the air-conditioning fan 192.

The air-conditioning fan 192 in this embodiment is configured of a centrifugal fan that blows the air drawn thereinto from the axial direction toward the outside thereof in the radial direction. The air-conditioning fan 192 is not limited to the centrifugal fan and may be configured of an axial fan, a circulating fan, or the like.

The evaporator 13 is disposed on the air-flow downstream side of the air-conditioning blower 19A. The evaporator 13 configures a cooling portion that cools the ventilation air to be blown into the vehicle interior. The evaporator 13 is a heat exchanger that absorbs, from the ventilation air, latent heat of evaporation of a low-temperature refrigerant circulating therethrough, thereby cooling the ventilation air.

As shown in FIG. 12, in this embodiment, a center partition plate 116 is integrally formed in the air-conditioning case 11. The center partition plate 116 partitions a ventilation passage, located on the air-flow downstream side of the evaporator 13, into a first ventilation passage 117 and a second ventilation passage 118.

The first ventilation passage 117 is a passage that guides the ventilation air to a driver-seat-side air outlet for blowing out air toward a driver's seat. Although not shown, the driver-seat-side air outlets include a face air outlet, a foot air outlet, and a defroster air outlet. The face air outlet blows air toward the upper body of an occupant on the driver's seat. The foot air outlet blows air toward the lower body of the occupant on the driver's seat. The defroster air outlet blows air toward a windshield of the vehicle.

As shown in FIG. 11, a driver-seat-side mode switching door 119 is provided at an air-flow downstream part of the first ventilation passage 117. The driver-seat-side mode switching door 119 serves to set a blowing mode of the air from the driver-seat-side air outlet. The driver-seat-side mode switching door 119 is driven by an actuator (not shown).

The second ventilation passage 118 is a passage that guides the ventilation air to a front-passenger-seat-side air outlet for blowing out air toward a front passenger's seat. Although not shown, the front-passenger-seat-side air outlets include a face air outlet, a foot air outlet, and a defroster air outlet. The face air outlet blows air toward the upper body of an occupant on the front passenger's seat. The foot air outlet blows air toward the lower body of the occupant on the front passenger's seat. The defroster air outlet blows air toward a windshield of the vehicle.

A front-passenger-seat-side mode switching door 120 is provided at an air-flow downstream part of the second ventilation passage 118. The front-passenger-seat-side mode switching door 120 serves to set a blowing mode of the air from the front-passenger-seat-side air outlet. The front-passenger-seat-side mode switching door 120 is driven by an actuator (not shown).

A first air mix door 181 is rotatably disposed between the evaporator 13 and the heater core 14 in the first ventilation passage 117. The first air mix door 181 is driven by an actuator (not shown).

The first air mix door 181 is a member that adjusts the ratio of the air that circulates from the evaporator 13 to the heater core 14 side in the first ventilation passage 117 to the air that passes through the evaporator 13 in the first ventilation passage 117 and then circulates to a downstream side with respect to the heater core 14 while bypassing the heater core 14. That is, the first air mix door 181 is a member that regulates the temperature of the ventilation air to be blown toward the driver's seat by adjusting the ratio of the air passing through the heater core 14 to the air bypassing the heater core 14.

A second air mix door 182 is rotatably disposed between the evaporator 13 and the heater core 14 in the second ventilation passage 118. The second air mix door 182 is driven by an actuator (not shown).

The second air mix door 182 is a member that adjusts the ratio of the air that circulates from the evaporator 13 to the heater core 14 side in the second ventilation passage 118 to the air that passes through the evaporator 13 in the second ventilation passage 118 and then circulates to a downstream side with respect to the heater core 14 while bypassing the heater core 14. That is, the second air mix door 182 is a member that regulates the temperature of the ventilation air to be blown toward the front passenger's seat by adjusting the ratio of the air passing through the heater core 14 to the air flowing while bypassing the heater core 14.

The first air mix door 181 and the second air mix door 182 are controlled independently. In this way, the temperature of the ventilation air blown toward the driver's seat and the temperature of the ventilation air blown toward the front passenger's seat are controlled independently.

The air-conditioning case 11 has the cold-air guiding portion 112 formed on the bottom surface portion thereof. The cold-air guiding portion 112 is one opening through which part of the ventilation air (i.e., cooled air) cooled by the evaporator 13 in the air-conditioning case 11 is guided out toward the outside of the air-conditioning case 11.

In more details, the cold-air guiding portion 112 is formed in a part of the bottom surface portion of the air-conditioning case 11 that is located between the evaporator 13 and the heater core 14. The cold-air guiding portion 112 is formed to straddle the first ventilation passage 117 and the second ventilation passage 118. Thus, the cooled air produced by the evaporator 13 can be taken out of both the first ventilation passage 117 and the second ventilation passage 118. The bottom surface portion of the air-conditioning case 11 is a part configuring a lower-side wall surface that faces the bottoms of the evaporator 13, heater core 14, and the like in the air-conditioning case 11.

Subsequently, the humidification device 50 in this embodiment will be described below. The humidification device 50 is disposed under the air-conditioning unit 10B and below the dashboard of the vehicle, like the air-conditioning unit 10B.

The humidification device 50 accommodates the adsorber 60 in the adsorption case 51 forming an outer shell of the humidification device. The adsorber 60 includes the adsorbent that adsorbs and desorbs moisture. The adsorption case 51 is a component separately formed from the air-conditioning case 11.

The adsorption case 51 is provided with a cold-air introduction passage 512, a cold-air guiding passage 513, a pre-humidification air passage 514, a post-humidification air passage 515, and the adsorber accommodating portion 54. In this embodiment, the cold-air introduction passage 512 corresponds to inner passages of the cold-air suction portion 52 and cold-air suction duct 521 in the first embodiment. In this embodiment, the cold-air guiding passage 513 corresponds to inner passages of the cold-air discharge portion 56 and cold-air discharge duct in the first embodiment. In this embodiment, the post-humidification air passage 515 corresponds to inner passages of the hot-air discharge portion 57 and humidification duct 571 in the first embodiment.

The cold-air introduction passage 512 has its end on the air-flow upstream side connected to the cold-air guiding portion 112 of the air-conditioning case 11, and its end on the air-flow downstream side connected to the adsorber accommodating portion 54. Thus, the cooled air taken out of both the first ventilation passage 117 and the second ventilation passage 118 is guided to the adsorber 60 via the cold-air introduction passage 512.

A cold-air passage door 90 is disposed at a part on the air-flow upstream side of the cold-air introduction passage 512 so as to open and close the cold-air guiding portion 112 of the air-conditioning case 11. The cold-air passage door 90 is driven by an actuator (not shown).

The cold-air guiding passage 513 has its end on the air-flow upstream side connected to the adsorber 60, and its end on the air-flow downstream side opened at the inside of the dashboard. In this way, the cold air flowing through the adsorber 60 is blown out into the internal space of the dashboard.

The pre-humidification air passage 514 has its end on the air-flow upstream side opened within the vehicle interior, and its end on the air-flow downstream side connected to the adsorber accommodating portion 54. Thus, the pre-humidification air (i.e., heated air) directly taken in from the vehicle interior is guided into the adsorber 60 via the pre-humidification air passage 514.

A humidification blower 91 and a pre-humidification air passage door 92 are disposed at parts on the air-flow upstream side of the pre-humidification air passage 514. The humidification blower 91 serves to supply the air located in the vehicle interior to the pre-humidification air passage 514. The pre-humidification air passage door 92 acts to open and close the pre-humidification air passage 514. The humidification blower 91 includes a humidification fan and a humidification motor. The pre-humidification air passage door 92 is driven by an actuator (not shown).

The post-humidification air passage 515 has its end on the air-flow upstream side connected to the adsorber 60, and its end on the air-flow downstream side opened at a part of the dashboard existing near an occupant's face (for example, a meter hood). Thus, the post-humidification air having passed through the adsorber 60 is blown toward the occupant's face, thereby humidifying a space around the occupant's face.

The adsorber accommodating portion 54 is a part that accommodates the adsorber 60 therein. The adsorber accommodating portion 54 in this embodiment has substantially the same basic structure as the adsorber accommodating portion 54 of the first embodiment shown in FIGS. 3 and 4. Thus, in this embodiment, different parts from the first embodiment will be mainly described, and thus a description of common parts thereto will be omitted or simplified.

The adsorber accommodating portion 54 in this embodiment sets, as the accommodating space 541, a space for circulation of the cooled air introduced via the cold-air introduction passage 512 and a space for circulation of the heated air introduced via the pre-humidification air passage 514.

Specifically, the accommodating space 541 is partitioned into the space for circulation of the cooled air and the space for circulation of the heated air by first and second partition members 542 and 543. The first and second partition members 542 and 543 are provided on both the air-flow upstream and downstream sides of the adsorber 60 as shown in FIGS. 3 and 4.

In the adsorber accommodating portion 54, the adsorber 60 is disposed to straddle both the space for circulation of the cooled air and the space for circulation of the heated air. The space for circulation of the cooled air in the adsorber accommodating portion 54 configures the moisture-adsorption space 541a that allows moisture contained in the cooled air to be adsorbed in the adsorbent of the adsorber 60, like the first embodiment. The space for circulation of the heated air in the adsorber accommodating portion 54 configures the moisture-desorption space 541b that desorbs moisture adsorbed in the adsorbent of the adsorber 60 therefrom and humidifies the heated air with the moisture, like the first embodiment.

The gas-gas heat exchanger 58 is disposed in the cold-air guiding passage 513 and the post-humidification air passage 515. The gas-gas heat exchanger 58 exchanges heat between the air (i.e., cold air) passing through the moisture-adsorption space 541a of the adsorber accommodating portion 54 and the air (i.e., hot air) passing through the moisture-desorption space 541b.

The gas-gas heat exchanger 58 in this embodiment has substantially the same structure as the gas-gas heat exchanger 58 in the first embodiment shown in FIG. 5. That is, as shown in FIG. 5, in the gas-gas heat exchanger 58, flow paths 58a for circulation of the cold air and flow paths 58b for circulation of the hot air are independently formed not to mix the cold air and hot air therein.

The structures of other components of the vehicle air conditioner in this embodiment are substantially the same as those in the first embodiment, and thus a detailed description thereof will be omitted by quoting the description of the first embodiment. For example, the vehicle air conditioner in this embodiment includes the controller 100 shown in FIG. 6, like the first embodiment.

Next, a description will be given on the operations of the air-conditioning unit 10B and the humidification device 50 in this embodiment. First, the outline of the operation of the air-conditioning unit 10B will be described.

In the air-conditioning unit 10B, when the air-conditioning operation switch 103a is turned on, the controller 100 calculates target air outlet temperatures TAO for both sides of the driver's seat and the front passenger's seat, based on detection signals from the group 101 of the respective sensors for the air-conditioning control and the preset temperature set by the temperature setting switch 103c. The controller 100 controls the operations of the respective components in the air-conditioning unit 10B such that the temperature of the ventilation air to be blown to the driver's seat side and the temperature of the ventilation air to be blown to the front passenger's seat approach the respective target air outlet temperatures TAO.

In this way, the controller 100 in the air-conditioning unit 10B controls the respective components according to the detection signals or the like from the group 101 of the respective sensors for the air-conditioning control, thereby making it possible to achieve the appropriate temperature adjustment of the vehicle interior as requested by the user.

Subsequently, the operation of the humidification device 50 will be described below. In this embodiment, the controller 100 basically executes control processing as shown in the flowchart of FIG. 7, like the first embodiment. That is, the controller 100 determines whether a humidification request is made or not by detecting on or off of the humidification operation switch 103b. If the humidification request is consequently determined to be made, the controller 100 executes the humidification operation of the vehicle interior by using the humidification device 50.

Specifically, the controller 100 rotates the cold-air passage door 90 to a position where the cold-air guiding portion 112 is opened, and also rotates the pre-humidification air passage door 92 to a position where the pre-humidification air passage 514 is opened. The controller 100 operates the humidification blower 91 and operates the driving member 70 to thereby rotate the adsorber 60 at a predetermined rotational speed (for example, 5 rpm).

At this time, the controller 100 controls an electric motor 72 of the driving member 70 such that the adsorbent sufficiently desorbing moisture in the desorption space 541b moves to the moisture-adsorption space 541a of the adsorber accommodating portion 54. For example, the controller 100 controls the electric motor 72 such that when a reference time is defined as a time required to desorb moisture from the adsorbent in the moisture-desorption space 541b, the adsorbent is moved to the moisture-adsorption space 541a after the reference time has elapsed since the movement of the adsorbent to the moisture-desorption space 541b.

Here, a description will be given on the operating state of the humidification device 50 when the controller 100 executes the humidification operation, with reference to FIG. 11 and FIG. 12.

The cold-air guiding portion 112 is opened, so that part of the low-temperature and high-humidity cooled air produced by the evaporator 13 (for example, at a temperature of 5° C. and a relative humidity of 70%) is divided and flows from both the first ventilation passage 117 and second ventilation passage 118 into the cold-air introduction passage 512. Thus, the part of the cooled air is introduced into the adsorber accommodating portion 54 via the cold-air introduction passage 512. Then, the moisture that is contained in the cooled air introduced into the adsorber accommodating portion 54 is adsorbed into the adsorbent existing in the moisture-adsorption space 541a of the adsorber 60.

At this time, since the adsorber 60 rotates within the accommodating space 541, the adsorbent that sufficiently desorbs moisture in the desorption space 541b of the adsorber 60 moves to the moisture-adsorption space 541a. Thus, the moisture contained in the cooled air introduced into the adsorber accommodating portion 54 is continuously adsorbed into the adsorbent existing in the moisture-adsorption space 541a at the adsorber 60.

Subsequently, the air passing through the moisture-adsorption space 541a is guided to the gas-gas heat exchanger 58 via the cold-air guiding passage 513 and passes through the gas-gas-heat exchanger 58. Then, the air is guided again to the cold-air guiding passage 513 to be blown into the internal space of the dashboard. Thus, the cold air at a low humidity hardly flows into the vehicle interior.

The pre-humidification air passage 514 is opened, and the humidification blower 91 is operated, so that dried air in the vehicle interior (for example, at a temperature of 25° C. and a relative humidity of 20%) is introduced into the adsorber accommodating portion 54 via the pre-humidification air passage 514. The pre-humidification air introduced into the adsorber accommodating portion 54 is humidified (for example, at a temperature of 21° C. and a relative humidity of 57%) with moisture adsorbed in and then desorbed from the adsorbent existing in the moisture-desorption space 541b of the adsorber 60.

At this time, since the adsorber 60 rotates within the accommodating space 541, the adsorbent that sufficiently adsorbs moisture in the moisture-adsorption space 541a of the adsorber 60 moves to the moisture-desorption space 541b. Thus, the pre-humidification air introduced into the adsorber accommodating portion 54 is continuously humidified by the moisture desorbed from the adsorbent existing in the moisture-adsorption space 541a of the adsorber 60.

Subsequently, the post-humidification air, humidified in the moisture-desorption space 541b, is guided to the gas-gas heat exchanger 58 via the post-humidification air passage 515 and then flows into the gas-gas heat exchanger 58. The post-humidification air flowing into the gas-gas heat exchanger 58 exchanges heat with the cold air flowing through the gas-gas heat exchanger 58. Thus, the air has its temperature decreased and its relative humidity increased (for example, at a temperature of 18° C. and a relative humidity of 65%). Then, the post-humidification air having passed through the gas-gas heat exchanger 58 is guided again to the post-humidification air passage 515 and then blown toward the occupant's face, thereby humidifying a space around the occupant's face.

The controller 100 determines whether a humidification stop request is made or not during execution of the above-mentioned humidification operation. If the humidification stop request is determined not to be made as a result of the determination process, the controller 100 continues the humidification operation. On the other hand, if the humidification stop request is determined to be made as a result of the determination process, the controller 100 executes the desorption operation of desorbing moisture adsorbed in the adsorbent of the adsorber 60.

Specifically, the controller 100 closes the cold-air guiding portion 112 by the cold-air passage door 90, while rotating the adsorber 60 by the driving member 70 during execution of the desorption operation. Thus, the low-temperature and high-humidity cooled air produced by the evaporator 13 does not flow into the adsorber accommodating portion 54, and the adsorption of moisture in the adsorbent existing in the moisture-adsorption space 541a of the adsorber 60 is stopped.

The pre-humidification air passage 514 is opened, and the humidification blower 91 is operated, so that dried air in the vehicle interior is introduced into the adsorber accommodating portion 54 via the pre-humidification air passage 514. Thus, the moisture adsorbed in the adsorbent existing in the moisture-desorption space 541b of the adsorber 60 is desorbed therefrom.

In this way, when the humidification stop request is made, the humidification device 50 in this embodiment stops the adsorption of the moisture in the adsorbent of the moisture-adsorption space 541a and continues desorption of the moisture from the adsorbent in the moisture-adsorption space 541a. Consequently, the moisture adsorbed in the adsorbent can be desorbed.

The controller 100 continues the desorption operation until a preset operation duration time has elapsed. After the operation duration time has elapsed since the start of the desorption operation, the controller 100 stops the operations of the respective components of the humidification device 50 and ends the control processing. The operation duration time may be set at a time required to cause the humidification device 50 to desorb the whole moisture adsorbed in the adsorbent existing in the moisture-desorption space 541b.

The vehicle air conditioner in this embodiment, mentioned above, can obtain the following effects.
(a) In this embodiment, the moisture of the cooled air produced by the air-conditioning unit 10B can be used to humidify the vehicle interior. Thus, water does not need to be supplied from the outside to the vehicle air conditioner. In this embodiment, the moisture adsorbed in the adsorbent is desorbed into the dried air in the vehicle interior. Thus, a heat source for desorbing the moisture does not need to be prepared.
(b) In this embodiment, the cooled air is taken out of both the first ventilation passage 117 and the second ventilation passage 118 to be guided into the adsorber 60. Thus, the cooled air can be taken in the vehicle air conditioner substantially uniformly from both the first and second ventilation passages 117 and 118. Accordingly, this embodiment can reduce the influence on the temperature control and the air-distribution ratio of the ventilation air in the first ventilation passage 117 and the second ventilation passage 118.
(c) The humidification device 50 includes the driving member 70. The driving member 70 moves a part of the adsorbent existing in the moisture-adsorption space 541a of the adsorber 60 to the moisture-desorption space 541b, while moving a part of the adsorbent existing in the moisture-desorption space 541b of the adsorber 60 to the moisture-adsorption space 541a.

Thus, the moisture adsorbed into the adsorbent in the moisture-adsorption space 541a can be desorbed from the adsorbent in the moisture-desorption space 541b, thereby humidifying the pre-humidification air with the moisture. Concurrently, the adsorbent desorbing the moisture in the moisture-desorption space 541b can adsorb the moisture of the cooled air circulating through the moisture-adsorption space 541a.

Therefore, the humidification device 50 and the vehicle air conditioner in this embodiment can achieve the continuous humidification of the vehicle interior without being supplied with water.
(d) In this embodiment, the gas-gas heat exchanger 58 is provided to exchange heat between the cooled air passing through the moisture-adsorption space 541a and the post-humidification air passing through the moisture-desorption space 541b. Thus, the gas-gas heat exchanger 58 cools the air having passed through the moisture-desorption space 541b by using the air (i.e., cooled air) having passed through the moisture-adsorption space 541a, so that the post-humidification air blown into the vehicle interior can have a high relative humidity. As a result, the comfort for the occupant can be improved because of the humidification of the vehicle interior.
(e) In this embodiment, the controller 100 executes the desorption operation that desorbs moisture, adsorbed in the adsorbent, when stopping the humidification of the vehicle interior. Thus, breeding of germs in the presence of moisture remaining in the adsorbent can be suppressed during stopping the humidification device 50, thereby ensuring the comfort for the occupant because of the humidification of the vehicle interior.
(f) The adsorbent tends to exhibit the feature that the adsorption rate of moisture per unit mass becomes slower than the desorption rate of moisture per unit mass.

When taking this into account, in this embodiment, the accommodating space 541 within the adsorption case 51 is partitioned such that the amount of the adsorbent existing in the moisture-adsorption space 541a is more than the amount of the adsorbent existing in the moisture-desorption space 541b.

Thus, the adsorption amount of moisture into the adsorbent can be sufficiently ensured in the moisture-adsorption space 541a, thereby making it possible to efficiently desorb the moisture adsorbed by the adsorbent in the moisture-desorption space 541b, ensuring the sufficient humidification amount.

### Fifth Embodiment

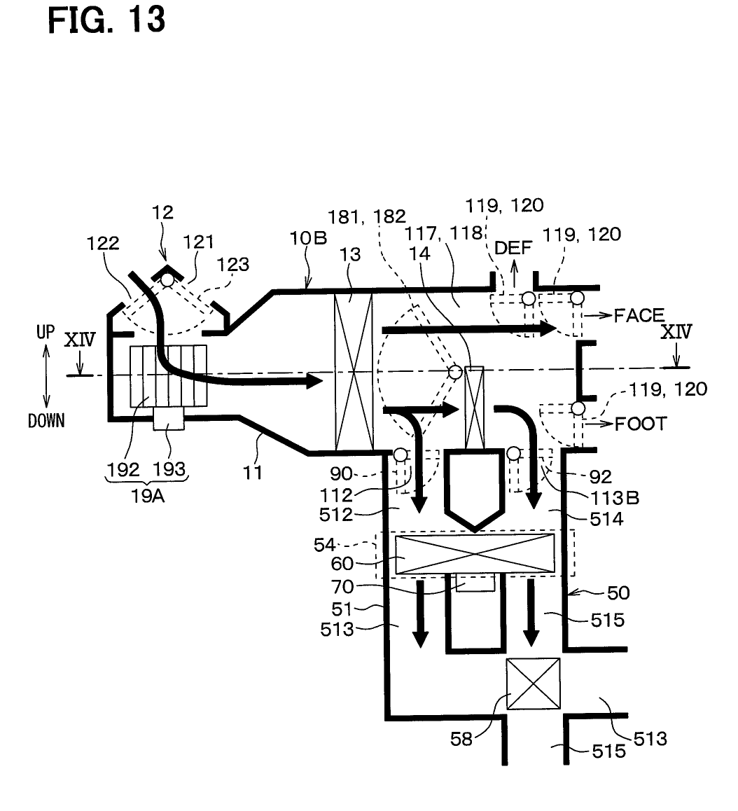

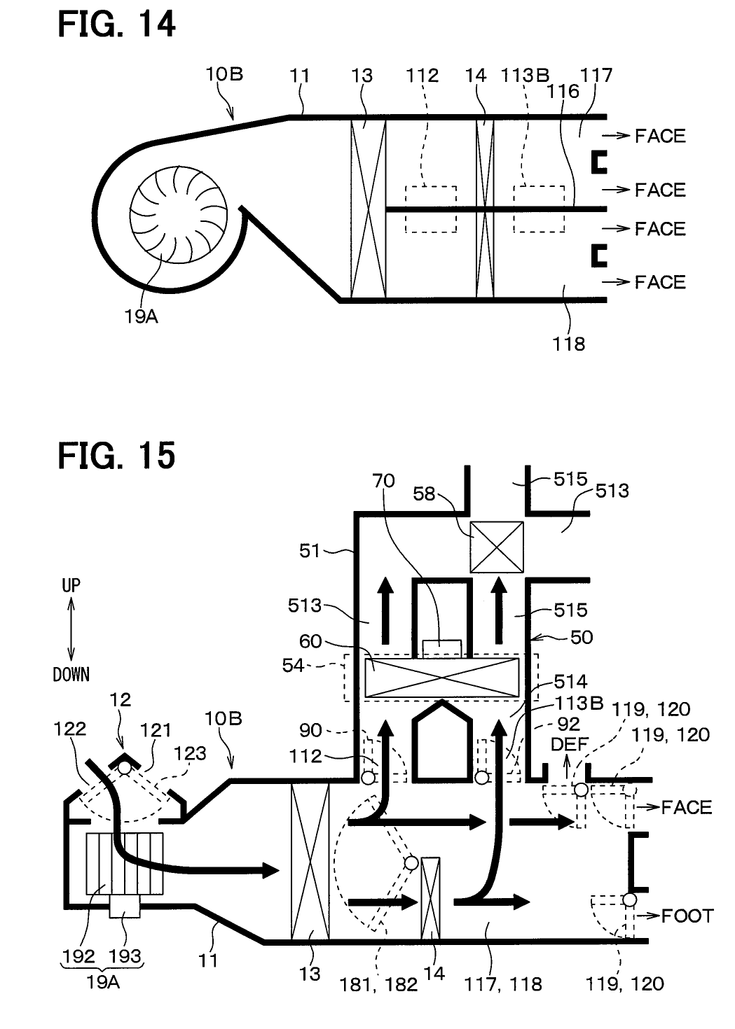

A fifth embodiment will be described with reference to FIGS. 13 and 14. This embodiment differs from the fourth embodiment in that the moisture adsorbed in the adsorbent is desorbed by using the high-temperature and low-humidity air cooled in the evaporator 13 and heated by the heater core 14. In this embodiment, the description of the same or equivalent parts as those in the fourth embodiment will be omitted or simplified.

As shown in FIGS. 13 and 14, the air-conditioning case 11 has a pre-humidification air guiding portion 113B formed on the bottom surface portion thereof. The pre-humidification air guiding portion 113B is an opening through which part of the ventilation air cooled by the evaporator 13 and heated by the heater core 14 in the air-conditioning case 11 is guided out toward the outside of the air-conditioning case 11. The pre-humidification air guiding portion 113B is an opening corresponding to the hot-air guiding portion 113 of the first embodiment.

In more details, the pre-humidification air guiding portion 113B is formed at a part of the bottom surface portion of the air-conditioning case 11 that is located on the air-flow downstream side with respect to the heater core 14. The pre-humidification air guiding portion 113B is formed to straddle the first ventilation passage 117 and the second ventilation passage 118. Thus, in this embodiment, the ventilation air cooled by the evaporator 13 and heated by the heater core 14 can be taken out of both the first ventilation passage 117 and the second ventilation passage 118.

The pre-humidification air passage 514 has its end on the air-flow upstream side connected to the pre-humidification air guiding portion 113B of the air-conditioning case 11, and its end on the air-flow downstream side connected to the adsorber accommodating portion 54. The pre-humidification air guiding portion 113B is opened and closed by a pre-humidification air passage door 92. In this embodiment, the humidification blower 91 employed in the fourth embodiment is eliminated. The pre-humidification air passage 514 in this embodiment corresponds to inner passages of the hot-air suction portion 53 and hot-air suction duct 531 in the first embodiment.

In the vehicle air conditioner of this embodiment, the pre-humidification air guiding portion 113B is opened when the controller 100 executes the humidification operation. Thus, in this embodiment, part of the high-temperature and low-humidity air cooled by the evaporator 13 and heated by the heater core 14 is divided and flows from both the first ventilation passage 117 and the second ventilation passage 118 into the pre-humidification air passage 514. Then, the part of the air is introduced into to the adsorber accommodating portion 54 via the pre-humidification air passage 514.

The pre-humidification air introduced into the adsorber accommodating portion 54 is humidified with moisture adsorbed in and then desorbed from the adsorbent existing in the moisture-desorption space 541b of the adsorber 60.

The high-temperature and low-humidity air cooled by the evaporator 13 and heated by the heater core 14 has a lower relative humidity than the air in the vehicle interior. Therefore, the vehicle air conditioner according to this embodiment increases the amount of humidification for the pre-humidification air, thereby more surely humidifying the space around the occupant's face.

The vehicle air conditioner in this embodiment, mentioned above, can obtain the same effects as in the fourth embodiment.

In the vehicle air conditioner of this embodiment, the moisture adsorbed in the adsorbent is desorbed by using the high-temperature and low-humidity pre-humidification air cooled by the evaporator 13 and heated by the heater core 14. Thus, the vehicle air conditioner in this embodiment increases the amount of humidification for the pre-humidification air, thereby more surely humidifying the space around the occupant's face.

In this embodiment, the humidification blower 91 employed in the fourth embodiment is eliminated, thereby making it possible to decrease the number of parts included in the vehicle air conditioner.

In this embodiment, the cold-air guiding portion 112 and the pre-humidification air guiding portion 113B are formed at the bottom surface portion of the air-conditioning case 11. However, for example, like a modified example shown in FIG. 15, the cold-air guiding portion 112 and the pre-humidification air guiding portion 113B may be formed at an upper surface portion of the air-conditioning case 11. The upper surface portion of the air-conditioning case 11 is a part configuring an upper-side wall surface that faces the bottom surface portion of the air-conditioning case 11.

### Sixth Embodiment

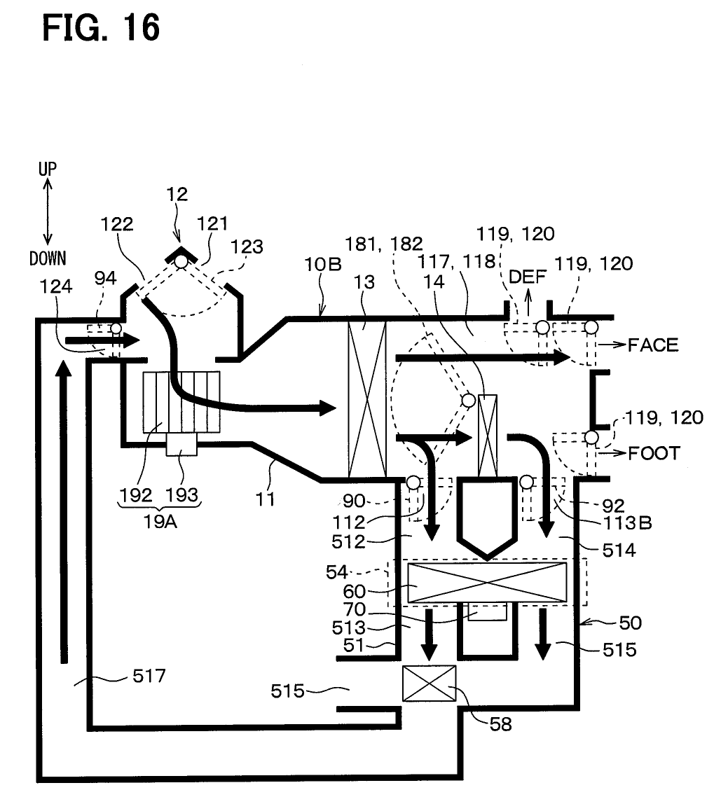

A sixth embodiment will be described with reference to FIG. 16. This embodiment differs from the fifth embodiment in that the cold air having passed through the adsorber 60 is returned to the inside/outside air switching box 12. In this embodiment, the description of the same or equivalent parts as those in the fifth embodiment will be omitted or simplified.

As shown in FIG. 16, the inside/outside air switching box 12 is provided with a cold-air introduction port 124 from which cold air having passed through the adsorber 60 and the gas-gas heat exchanger 58 is introduced into the inside/outside air switching box. The cold-air introduction port 124 is connected to flow paths 58a for circulation of the cold air in the gas-gas heat exchanger 58 shown in FIG. 5, via a cooled-air return passage 517.

A cold-air return passage door 94 is disposed at a part on the air-flow downstream side of the cooled-air return passage 517 so as to open and close the cold-air introduction port 124. The cold-air return passage door 94 is driven by an actuator (not shown).

The cold-air return passage door 94 is controlled by the controller 100 shown in FIG. 6. The controller 100 rotates the cold-air return passage door 94 to a position where the cold-air introduction port 124 is opened when executing the humidification operation. In this way, when executing the humidification operation, the cold air having passed through the adsorber 60 is returned to the inside/outside air switching box 12.

If the cold air having passed through the adsorber 60 is blown into the space inside the dashboard as in the case of the fourth and fifth embodiments, the occupant might feel uncomfortable. In contrast, like this embodiment, the cold air having passed through the adsorber 60 is returned to the inside/outside air switching box 12, thereby preventing the occupant from feeling uncomfortable.

The vehicle air conditioner in this embodiment, mentioned above, can obtain the same effects as in the fifth embodiment.

When executing the humidification operation, the cold air having passed through the adsorber 60 is returned to the inside/outside air switching box 12, so that the occupant can be prevented from feeling uncomfortable. Like this embodiment, the structure in which the cooled-air return passage 517 is provided can also apply to other structures described in the following embodiments.

### Seventh Embodiment

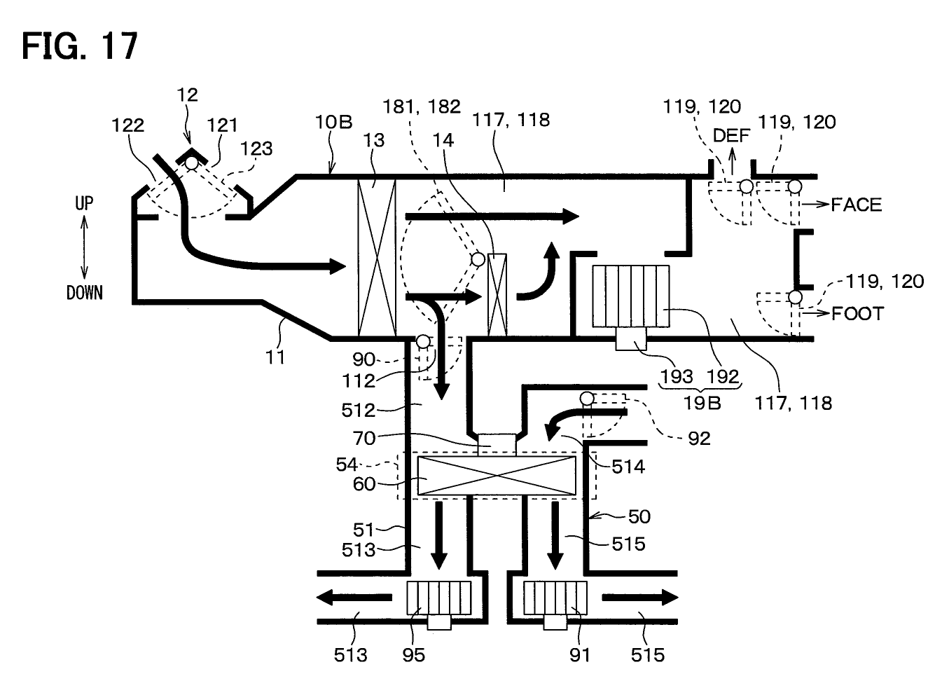

A seventh embodiment will be described with reference to FIG. 17. This embodiment differs from the fourth embodiment in that suction blowers are used as an air-conditioning blower 19B and the humidification blower 91. In this embodiment, the description of the same or equivalent parts as those in the fourth embodiment will be omitted or simplified.

As shown in FIG. 17, the air-conditioning blower 19B is a suction blower. The air-conditioning blower 19B is disposed on the air-flow downstream side with respect to the heater core 14 and on the air-flow upstream side with respect to the driver-seat-side mode switching door 119 and the front-passenger-seat-side mode switching door 120 in the first ventilation passage 117 and the second ventilation passage 118. The operation of the air-conditioning blower 19B generates an air flow within the air-conditioning case 11, which is to be blown into the vehicle interior.

The humidification blower 91 is disposed in the post-humidification air passage 515 located in the air-flow downstream side with respect to the adsorber 60. The humidification blower 91 is a suction blower and is configured of a humidification fan, a humidification motor, and the like. The operation of the humidification blower 91 draws the pre-humidification air (i.e., heated air) from the vehicle interior. The pre-humidification air is guided to the adsorber 60 via the pre-humidification air passage 514.

In this embodiment, a cold-air blower 95 is disposed in the cold-air guiding passage 513 located on the air-flow downstream side with respect to the adsorber 60. The cold-air blower 95 is a suction blower and is configured of a cold-air fan, a cold-air motor, and the like. Thus, the operation of the cold-air blower 95 draws the cooled air from both the first ventilation passage 117 and the second ventilation passage 118 in the air-conditioning case 11. Then, the cooled air is guided to the adsorber 60 via the cold-air introduction passage 512.

The vehicle air conditioner in this embodiment, mentioned above, can obtain the same effects as in the fourth embodiment.

### Eighth Embodiment

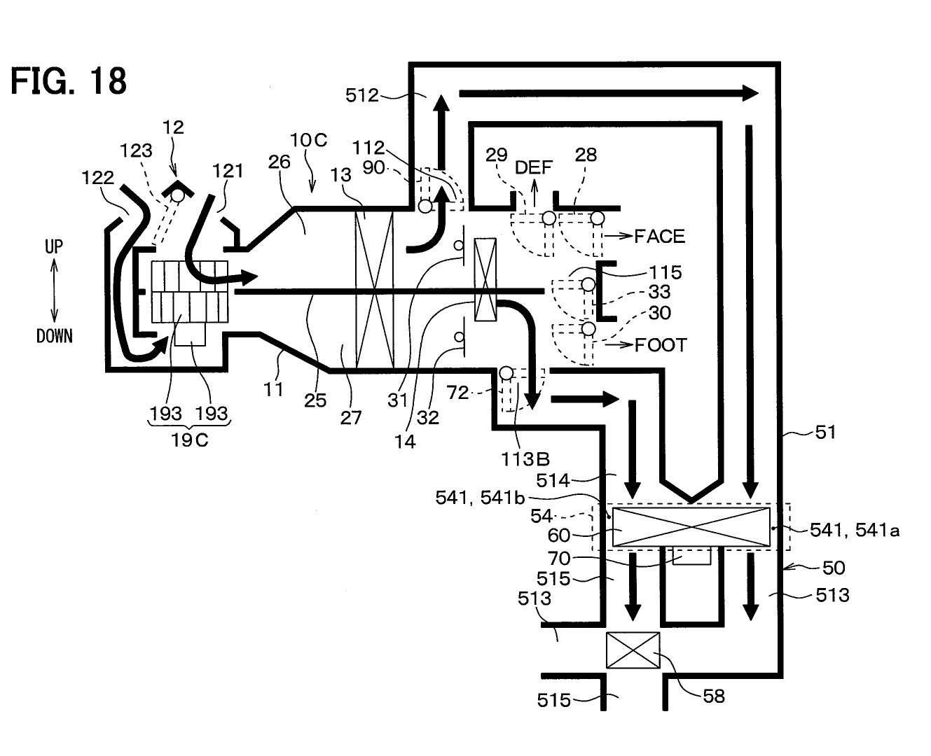

An eighth embodiment will be described with reference to FIG. 18. This embodiment differs from the fourth embodiment in that an air-conditioning unit 10C in use has an outside-air ventilation passage through which outside air passes and an inside-air ventilation passage through which inside air passes. In this embodiment, the description of the same or equivalent parts as those in the fourth embodiment will be omitted or simplified.

As shown in FIG. 18, an inside/outside air partition plate 25 is integrally formed in the air-conditioning case 11. The inside/outside air partition plate 25 partitions a ventilation passage in the air-conditioning case 11, located on the air-flow downstream side relative to the air-conditioning blower 19C, into an outside-air ventilation passage 26 and an inside-air ventilation passage 27. The outside-air ventilation passage 26 is provided at an upper part of the inside of the air-conditioning case 11, while the inside-air ventilation passage 27 is provided at a lower part of the inside of the air-conditioning case 11.

The air-conditioning blower 19C includes an outside-air fan for generating an air flow in the outside-air ventilation passage 26 and an inside-air fan for generating an air flow in the inside-air ventilation passage 27.

The inside/outside air switching door 123 can set an inside and outside air double-layered flow mode, an inside-air mode, and an outside-air mode.

The inside and outside air double-layered flow mode is a mode in which the outside-air introduction port 121 communicates only with the outside-air ventilation passage 26, and the inside-air introduction port 122 communicates only with the inside-air ventilation passage 27. In the inside and outside air double-layered flow mode, the entire outside air introduced from the outside-air introduction port 121 flows into the outside-air ventilation passage 26, while the entire inside air introduced from the inside-air introduction port 122 flows into the inside-air ventilation passage 27.

The inside-air mode is a mode in which the outside-air introduction port 121 is completely closed and the inside-air introduction port 122 is fully opened.

In the inside-air mode, the inside air introduced from the inside-air introduction port 122 flows into the outside-air ventilation passage 26 and the inside-air ventilation passage 27.

The outside-air mode is a mode in which the outside-air introduction port 121 is fully opened and the inside-air introduction port 122 is completely closed. In the outside-air mode, the outside air introduced from the outside-air introduction port 121 flows into the outside-air ventilation passage 26 and the inside-air ventilation passage 27.

The outside-air ventilation passage 26 is a passage that guides the ventilation air to a face air outlet and a defroster air outlet. The face air outlet is to blow air toward an occupant's upper body. The defroster air outlet is to blow air toward the windshield of the vehicle. An air-flow downstream side part of the outside-air ventilation passage 26 is provided with a face door 28 and a defroster door 29. The face door 28 serves to open and close a ventilation passage that leads to the face air outlet. The defroster door 29 serves to open and close the ventilation air passage that leads to the defroster air outlet. The face door 28 and the defroster door 29 are driven by actuators (not shown).

The inside-air ventilation passage 27 is a passage that guides the ventilation air to the foot air outlet for blowing out air toward the occupant's lower body. An air-flow downstream side part of the inside-air ventilation passage 27 is provided with a foot door 30. The foot door 30 serves to open and close a ventilation passage that leads to the foot air outlet. The foot door 30 is driven by an actuator (not shown).

An outside-air-side air mix door 31 is rotatably disposed between the evaporator 13 and the heater core 14 in the outside-air ventilation passage 26.

The outside-air-side air mix door 31 is driven by an actuator (not shown). The outside-air-side air mix door 31 is a member that adjusts the ratio of the air circulating from the evaporator 13 to a side of the heater core 14 in the outside-air ventilation passage 26 to the air passing through the evaporator 13 in the outside-air ventilation passage 26 and then circulating to a downstream side of the heater core 14 while bypassing the heater core 14. That is, the outside-air-side air mix door 31 is a member that regulates the temperature of ventilation air flowing through the outside-air ventilation passage 26.

An inside-air-side air mix door 32 is rotatably disposed between the evaporator 13 and the heater core 14 in the inside-air ventilation passage 27. The inside-air-side air mix door 32 is driven by an actuator (not shown). The inside-air-side air mix door 32 is a member that adjusts the ratio of the air circulating from the evaporator 13 to a side of the heater core 14 in the inside-air ventilation passage 27 to the air passing through the evaporator 13 in the inside-air ventilation passage 27 and then circulating to a downstream side of the heater core 14 while bypassing the heater core 14. That is, the inside-air-side air mix door 32 is a member that regulates the temperature of ventilation air flowing through the inside-air ventilation passage 27.

The outside-air-side air mix door 31 and the inside-air-side air mix door 32 are controlled independently. In this way, the temperature of the ventilation air blown from the face air outlet and the defroster air outlet and the temperature of the ventilation air blown from the foot air outlet are controlled independently.

In the air-conditioning case 11, a communication opening 115 is formed on the air-flow downstream side with respect to the heater core 14. The communication opening 115 communicates the outside-air ventilation passage 26 with the inside-air ventilation passage 27.

A communication door 33 that opens and closes the communication opening 115 is disposed at a part where the communication opening 115 is formed. The communication door 33 is driven by an actuator (not shown). The communication door 33 completely closes the communication opening 115 in the inside and outside air double-layered flow mode, and fully opens the communication opening 115 in the inside-air mode and the outside-air mode.

A cold-air guiding portion 112 is formed at an upper surface portion of the air-conditioning case 11. The cold-air guiding portion 112 is an opening through which part of the ventilation air (i.e., cooled air) cooled by the evaporator 13 in the outside-air ventilation passage 26 is guided out toward the outside of the air-conditioning case 11. The cold-air guiding portion 112 is connected to the cold-air introduction passage 512. Thus, the cooled air taken out of the outside-air ventilation passage 26 is guided to the adsorber 60 via the cold-air introduction passage 512.

The pre-humidification air guiding portion 113B is formed at the bottom surface portion of the air-conditioning case 11. The pre-humidification air guiding portion 113B is an opening through which part of the ventilation air cooled by the evaporator 13 and heated by the heater core 14 in the inside-air ventilation passage 27 is guided out toward the outside of the air-conditioning case 11. The pre-humidification air guiding portion 113B is connected to the pre-humidification air passage 514. Thus, the pre-humidification air (i.e., heated air) taken out of the inside-air ventilation passage 27 is guided to the adsorber 60 via the pre-humidification air passage 514. In this embodiment, the humidification blower 91 employed in the fourth embodiment is eliminated.

In the vehicle air conditioner of this embodiment, the cold-air guiding portion 112 is opened when the controller 100 executes the humidification operation. Thus, the low-temperature and high-humidity air (i.e., cooled air) taken out of the outside-air ventilation passage 26 is introduced into the adsorber accommodating portion 54 via the cold-air introduction passage 512. Then, the moisture that is contained in the cooled air introduced into the adsorber accommodating portion 54 is adsorbed into the adsorbent existing in the moisture-adsorption space 541a of the adsorber 60.

The pre-humidification air guiding portion 113B is opened, so that the high-temperature and low-humidity pre-humidification air (i.e., heated air) taken out of the inside-air ventilation passage 27 is introduced into the adsorber accommodating portion 54 via the pre-humidification air passage 514. The pre-humidification air introduced into the adsorber accommodating portion 54 is humidified with moisture adsorbed in and then desorbed from the adsorbent existing in the moisture-desorption space 541b of the adsorber 60.

For example, during air-cooling in summer, the relative humidity of the outside air tends to become higher than the relative humidity of the inside air. Thus, when the inside and outside air double-layered flow mode is set, the cooled air for adsorbing moisture into the adsorbent is taken out of the outside-air ventilation passage 26, while the pre-humidification air for desorbing moisture adsorbed in the adsorbent is taken out of the inside-air ventilation passage 27. Accordingly, the vehicle air conditioner of this embodiment can enlarge a difference in the relative humidity between the cooled air and the pre-humidification air to thereby improve the efficiency of the adsorbent, so that the high-humidity air can be supplied to the vehicle interior.

The air guided to the adsorber 60 is taken out of both the outside-air ventilation passage 26 and the inside-air ventilation passage 27, thereby making it possible to reduce the influence on the temperature control and the air-distribution ratio of the ventilation air in the outside-air ventilation passage 26 and the ventilation air in the inside-air ventilation passage 27.

The vehicle air-conditioner in this embodiment, mentioned above, can obtain the effects (a), (c), (d), (e) and (f) among the effects (a) to (f) obtained by the vehicle air conditioner in the fourth embodiment.

In the vehicle air conditioner of this embodiment, the adsorbent adsorbs moisture by using the cooled air at a high relative humidity taken out of the outside-air ventilation passage 26, and the adsorbent desorbs moisture therein by using the pre-humidification air at a low relative humidity taken out of the inside-air ventilation passage 27. Thus, the vehicle air conditioner of this embodiment can enlarge a difference in the relative humidity between the cooled air and the pre-humidification air to thereby improve the efficiency of the adsorbent, so that the high-humidity air can be supplied to the vehicle interior.

In the vehicle air conditioner of this embodiment, the air guided to the adsorber 60 is taken out of both the outside-air ventilation passage 26 and the inside-air ventilation passage 27. Thus, the vehicle air conditioner in this embodiment can take in the air substantially uniformly from both the outside-air ventilation passage 26 and the inside-air ventilation passage 27. Consequently, the vehicle air conditioner can reduce the influence on the temperature control and the air-distribution ratio of the ventilation air in the outside-air ventilation passage 26 and the ventilation air in the inside-air ventilation passage 27.

Here, in the vehicle air conditioner of this embodiment, the cooled-air return passage 517 shown in FIG. 16 may be added to the air-conditioning unit 10C, thereby allowing the cold air having passed through the adsorber 60 to return to the inside/outside air switching box 12.

### Ninth Embodiment

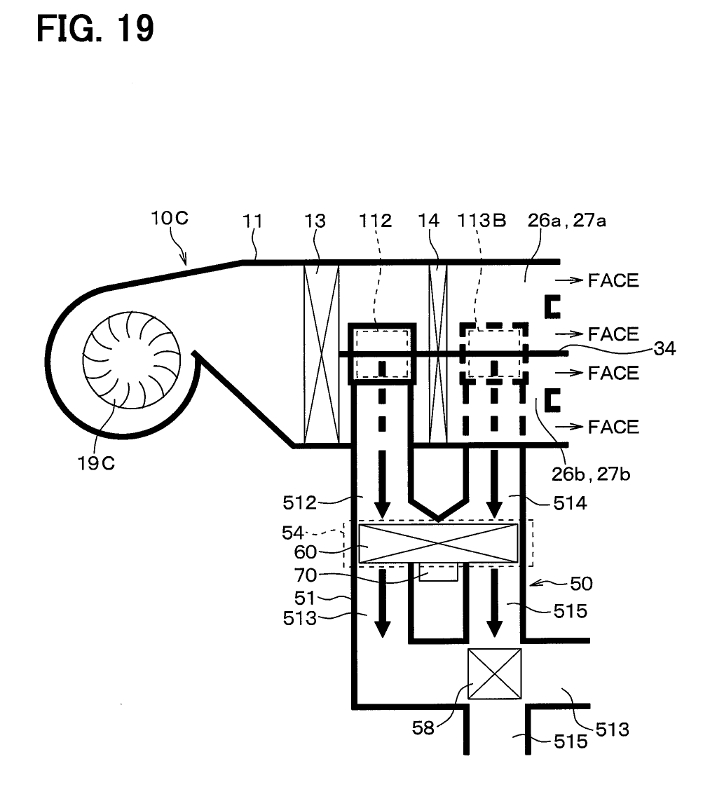

A ninth embodiment will be described with reference to FIG. 19. This embodiment differs from the eighth embodiment in that ventilation air having the temperatures controlled independently is guided to different sites (for example, on the driver's seat side and the front passenger's seat side) of the vehicle interior. In this embodiment, the description of the same or equivalent parts as those in the eighth embodiment will be omitted or simplified. FIG. 19 corresponds to a perspective view of the vehicle air conditioner as viewed from the above according to the ninth embodiment.

As shown in FIG. 19, in the vehicle air conditioner of this embodiment, a center partition plate 34 is added to the vehicle air conditioner of the eighth embodiment shown in FIG. 18.

The center partition plate 34 partitions a part of the outside-air ventilation passage 26 located on the air-flow downstream side with respect to the evaporator 13, into a first outside-air ventilation passage 26a and a second outside-air ventilation passage 26b. The first outside-air ventilation passage 26a is a passage that guides the ventilation air to the defroster air outlet and the face air outlet on the driver's seat side. The second outside-air ventilation passage 26b is a passage that guides the ventilation air to the defroster air outlet and the face air outlet on the front passenger's seat side.

The center partition plate 34 partitions a part of the inside-air ventilation passage 27 located on the air-flow downstream side with respect to the evaporator 13, into a first inside-air ventilation passage 27a and a second inside-air ventilation passage 27b. The first inside-air ventilation passage 27a is a passage that guides the ventilation air to the foot air outlet on the driver's seat side. The second inside-air ventilation passage 27b is a passage that guides the ventilation air to the foot air outlet on the front passenger's seat side.

The first outside-air ventilation passage 26a and the second outside-air ventilation passage 26b are provided with respective outside-air-side air mix doors 31 shown in FIG. 18, which are independently controlled. Thus, the temperature of the ventilation air blown from the defroster air outlet and the face air outlet on the driver's seat side and the temperature of the ventilation air blown from the defroster air outlet and the face air outlet on the front passenger's seat side are controlled independently.

The first inside-air ventilation passage 27a and the second inside-air ventilation passage 27b are provided with respective inside-air-side air mix doors 32 shown in FIG. 18, which are independently controlled. Thus, the temperature of the ventilation air blown from the foot air outlet on the driver's seat side and the temperature of the ventilation air blown from the foot air outlet on the front passenger's seat side are controlled independently.

The cold-air guiding portion 112 is formed to straddle the first outside-air ventilation passage 26a and the second outside-air ventilation passage 26b. Thus, the vehicle air conditioner in this embodiment can take out the cooled air produced by the evaporator 13 from both the first outside-air ventilation passage 26a and the second outside-air ventilation passage 26b.

The pre-humidification air guiding portion 113B is formed to straddle the first inside-air ventilation passage 27a and the second inside-air ventilation passage 27b. Thus, in the vehicle air conditioner of this embodiment, the ventilation air cooled by the evaporator 13 and heated by the heater core 14 can be taken out of both the first inside-air ventilation passage 27a and the second inside-air ventilation passage 27b.

In the vehicle air conditioner of this embodiment, the cold-air guiding portion 112 is opened when the controller 100 executes the humidification operation. Thus, the low-temperature and high-humidity air (i.e., cooled air) taken out of both the first outside-air ventilation passage 26a and the second outside-air ventilation passage 26b is introduced into the adsorber accommodating portion 54 via the cold-air introduction passage 512. Then, the moisture that is contained in the cooled air introduced into the adsorber accommodating portion 54 is adsorbed into the adsorbent existing in the moisture-adsorption space 541a of the adsorber 60.

The pre-humidification air guiding portion 113B is opened, so that the high-temperature and low-humidity pre-humidification air (i.e., heated air), taken out of both the first and second inside-air ventilation passages 27a and 27b, is introduced into the adsorber accommodating portion 54 via the pre-humidification air passage 514. The pre-humidification air introduced into the adsorber accommodating portion 54 is humidified with moisture adsorbed in and then desorbed from the adsorbent existing in the moisture-desorption space 541b of the adsorber 60.

Here, for example, during air-cooling in summer, the relative humidity of the outside air tends to become higher than the relative humidity of the inside air.

Thus, when the inside and outside air double-layered flow mode is set, the cooled air for adsorbing moisture into the adsorbent is taken out of the respective outside-air ventilation passages 26a and 26b, and the pre-humidification air for desorbing moisture adsorbed in the adsorbent is taken out of the respective inside-air ventilation passages 27a and 27b. Thus, the vehicle air conditioner in this embodiment can enlarge a difference in the relative humidity between the cooled air and the pre-humidification air to thereby improve the efficiency of the adsorbent, so that the high-humidity air can be supplied to the vehicle interior.

In the vehicle air conditioner of this embodiment, the cooled air for adsorbing moisture into the adsorbent is taken out of the first outside-air ventilation passage 26a and the second outside-air ventilation passage 26b. Thus, the vehicle air conditioner in this embodiment can reduce the influence on the temperature control and the air-distribution ratio of the ventilation air in the first outside-air ventilation passage 26a and the second outside-air ventilation passage 26b.

In the vehicle air conditioner of this embodiment, the pre-humidification air for desorbing moisture adsorbed in the adsorbent is taken out of the first inside-air ventilation passage 27a and the second inside-air ventilation passage 27b. Thus, the vehicle air conditioner in this embodiment can reduce the influence on the temperature control and the air-distribution ratio of the ventilation air in the first inside-air ventilation passage 27a and the second inside-air ventilation passage 27b.

The vehicle air-conditioner in this embodiment, mentioned above, can obtain the effects (a), (c), (d), (e) and (f) among the effects (a) to (f) obtained by the vehicle air conditioner in the fourth embodiment.

In the vehicle air conditioner of this embodiment, the adsorbent adsorbs moisture by using the cooled air at a high humidity taken out of the respective outside-air ventilation passages 26a and 26b, and the adsorbent desorbs moisture by using the pre-humidification air at a low humidity taken out of the respective inside-air ventilation passages 27a and 27b. Thus, the vehicle air conditioner of this embodiment can enlarge a difference in the relative humidity between the cooled air and the pre-humidification air to thereby improve the efficiency of the adsorbent, so that the high-humidity air can be supplied to the vehicle interior.

In the vehicle air conditioner of this embodiment, the cooled air for adsorbing moisture into the adsorbent is taken out of the first outside-air ventilation passage 26a and the second outside-air ventilation passage 26b. Thus, the vehicle air conditioner in this embodiment can reduce the influence on the temperature control and the air-distribution ratio of the ventilation air in the first outside-air ventilation passage 26a and the second outside-air ventilation passage 26b.

In the vehicle air conditioner of this embodiment, the pre-humidification air for desorbing moisture adsorbed in the adsorbent is taken out of the first inside-air ventilation passage 27a and the second inside-air ventilation passage 27b. Thus, the vehicle air conditioner in this embodiment can reduce the influence on the temperature control and the air-distribution ratio of the ventilation air in the first inside-air ventilation passage 27a and the second inside-air ventilation passage 27b.

In the vehicle air conditioner of this embodiment, the cooled-air return passage 517 shown in FIG. 16 may be added to the air-conditioning unit 10C, thereby allowing the cold air having passed through the adsorber 60 to return to the inside/outside air switching box 12.

### Tenth Embodiment

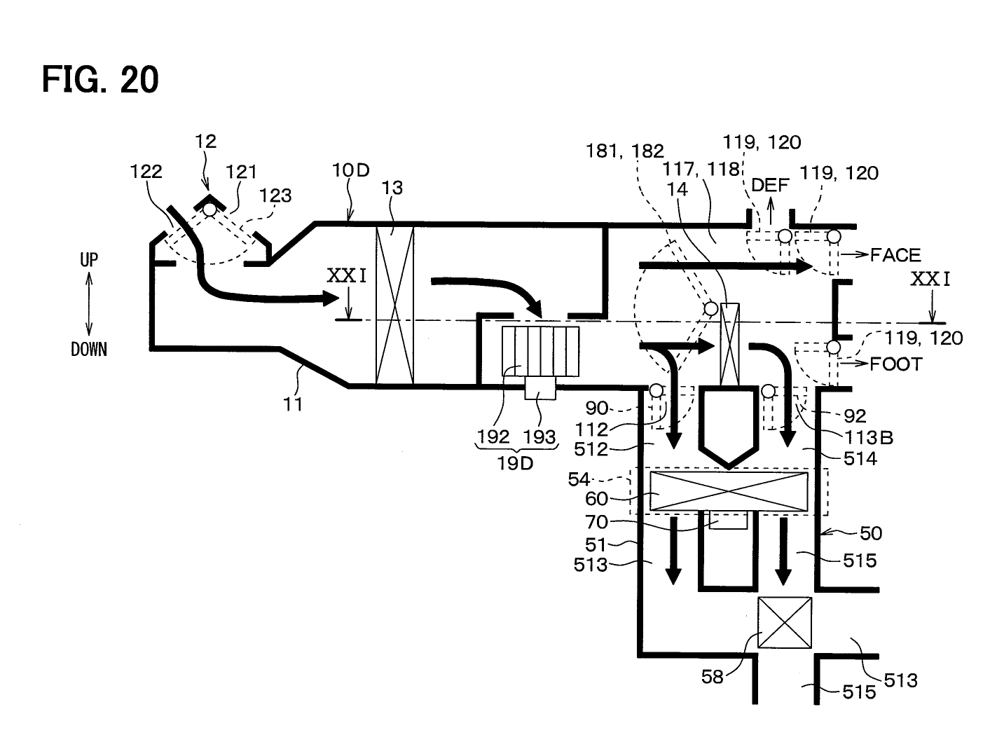

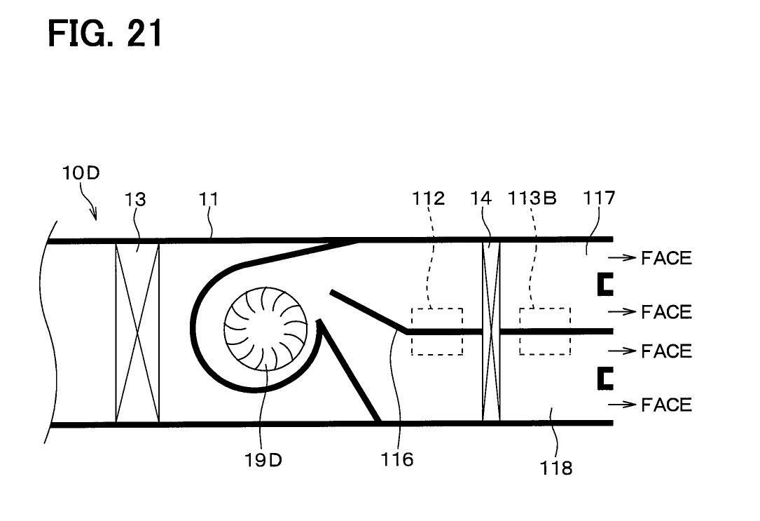

A tenth embodiment will be described with reference to FIGS. 20 and 21. This embodiment differs from the fifth embodiment in that the humidification device 50 is applied to an air-conditioning unit 10D in which an air-conditioning blower 19D is disposed on the air-flow downstream side of the evaporator 13 and on the air-flow upstream side of the heater core 14. In this embodiment, the description of the same or equivalent parts as those in the fifth embodiment will be omitted or simplified.

As shown in FIG. 20, the air-conditioning blower 19D is disposed on the air-flow downstream side with respect to the evaporator 13 and on the air-flow upstream side with respect to the heater core 14. The operation of the air-conditioning blower 19D generates an air flow within the air-conditioning case 11, which is to be blown into the vehicle interior.

As shown in FIG. 21, the partition plate 116 is disposed in the air-conditioning case 11 so as to partition the ventilation passage on the air-flow downstream side of the air-conditioning blower 19D into the first ventilation passage 117 and the second ventilation passage 118. In the air-conditioning case 11, the cold-air guiding portion 112 and the pre-humidification air guiding portion 1136 are formed on the bottom surface portion thereof.

The cold-air guiding portion 112 is one opening through which part of the ventilation air cooled by the evaporator in the air-conditioning case 11 is guided out toward the outside of the air-conditioning case 11. In more details, the cold-air guiding portion 112 is formed in a part of the bottom surface portion of the air-conditioning case 11 that is located between the air-conditioning blower 19D and the heater core 14. The cold-air guiding portion 112 is formed to straddle the first ventilation passage 117 and the second ventilation passage 118. Thus, in this embodiment, the ventilation air cooled by the evaporator 13 can be taken out of both the first ventilation passage 117 and the second ventilation passage 118.

The pre-humidification air guiding portion 113B is one opening through which part of the ventilation air cooled by the evaporator 13 and heated by the heater core 14 in the air-conditioning case 11 is guided out toward the outside of the air-conditioning case 11. In more details, the pre-humidification air guiding portion 113B is formed in a part of the bottom surface portion of the air-conditioning case 11 that is located on the air-flow downstream side with respect to the heater core 14. The pre-humidification air guiding portion 113B is formed to straddle the first ventilation passage 117 and the second ventilation passage 118. Thus, in this embodiment, the ventilation air cooled by the evaporator 13 and heated by the heater core 14 can be taken out of both the first ventilation passage 117 and the second ventilation passage 118.

The vehicle air conditioner in this embodiment differs from that in the fifth embodiment only in the position of the air-conditioning blower 19D, and the structures of other components of the vehicle air conditioner in this embodiment are the same as those in the fifth embodiment. Thus, the vehicle air conditioner in this embodiment can obtain the functions and effects exhibited by the structures common to those in the fifth embodiment in the same manner as in the fifth embodiment.

In this embodiment, the air-conditioning blower 19D is disposed between the evaporator 13 and the heater core 14 by way of example in the air-conditioning unit 10D in which the first and second ventilation passages 117 and 118 are set inside the air-conditioning case 11, but is not limited thereto.

Like the first to third embodiments, the air-conditioning blower 19 or 19A may be disposed between the evaporator 13 and the heater core 14 in the air-conditioning unit 10 or 10A in which the ventilation passage for single-layered air is set within the air-conditioning case 11.

Like the eighth and ninth embodiments, the air-conditioning blower 19C may be disposed between the evaporator 13 and the heater core 14 in the air-conditioning unit 10C that has the outside-air ventilation passage for circulation of the outside air and the inside-air ventilation passage for circulation of the inside air.

### Other Embodiments

Although the embodiments of the present disclosure have been described above, the present disclosure is not limited to the above-mentioned embodiments. Various modifications can be made as follows.
(1) Although in the respective above-mentioned embodiments, the humidification device 50 is applied to any one of the air-conditioning units 10 and 10A to 10D in which the ventilation air is cooled by the evaporator 13 and heated by the heater core 14 by way of example, the present disclosure is not limited thereto. For example, the humidification device 50 may be applied to the air-conditioning units 10 and 10A to 10D that adopt a cooling member, such as a Peltier element, as a cooling portion for cooling the ventilation air. Alternatively, the humidification device 50 may be applied to the air-conditioning units 10 and 10A to 10D that adopt an electric heater or a radiator of a refrigeration cycle as a heating portion for heating the ventilation air.
(2) Although in the above-mentioned first to third embodiments, the cold-air suction duct 521 of the humidification device 50 is connected to the cold-air guiding portion 112 that is opened at the bottom surface portion 11a of the air-conditioning case 11 by way of example, the present disclosure is not limited thereto. The cold-air suction duct 521 may be connected to the cold-air guiding portion 112 provided at the upper surface portion 11b or side surface portion 11c of the air-conditioning case 11.
(3) Although in the above-mentioned first to third embodiments, the hot-air suction duct 531 of the humidification device 50 is connected to the hot-air guiding portion 113 that is opened at the bottom surface portion 11a of the air-conditioning case 11 by way of example, the present disclosure is not limited thereto. The hot-air suction duct 531 may be connected to the hot-air guiding portion 113 provided at the upper surface portion 11b or the side surface portion 11c of the air-conditioning case 11.

The heated air produced by the heater core 14 is blown into the vehicle interior. Thus, the hot-air suction duct 531 may be connected to an opening that communicates with the vehicle interior, and the inside air may be introduced into the adsorption case 51 as the heated air produced by the heater core 14. That is, the air having lower humidity and higher temperature exists within the vehicle interior into which the heated air produced by any one of the air-conditioning unit 10 and 10A to 10D is blown, compared to the cooled air produced by the evaporator 13. Because of this, the inside air may be introduced into the adsorption case 51 as the heated air produced by the heater core 14.
(4) Although in the above-mentioned first to third embodiments, the adsorption case 51 is connected to the air-conditioning case 11 via the respective suction ducts 521 and 531 by way of example, the present disclosure is not limited thereto. The cold-air suction portion 52 and the hot-air suction portion 53 in the adsorption case 51 may be directly connected to the air-conditioning case 11. In this case, the cold-air suction portion 52 configures a first introduction portion, while the hot-air suction portion 53 configures a second introduction portion.
(5) Each of the above-mentioned embodiments has described an example in which the accommodating space 541 is partitioned such that the amount of the adsorbent 61 existing in the moisture-adsorption space 541a is less than that of the adsorbent 61 existing in the moisture-desorption space 541b when taking into account a difference between the adsorption rate and desorption rate of the adsorbent 61. However, the present disclosure is not limited thereto.

The volume of the cooled air circulating through the moisture-adsorption space 541a may be set larger than that of the heated air circulating through the moisture-desorption space 541b. With this arrangement, the adsorption amount of moisture into the adsorbent 61 in the moisture-adsorption space 541a can be sufficiently ensured, even when the amount of the adsorbent 61 existing in the moisture-adsorption space 541a is substantially equal to that of the adsorbent 61 existing in the moisture-desorption space 541b.
(6) Although each of the above-mentioned embodiments has described an example of a structure in which the adsorbent 61 is supported by a plurality of metal plate-shaped members as the adsorber 60, the present disclosure is not limited thereto. The adsorber 60 may be configured to support the adsorbent 61 in a structure body, for example, having a honeycomb structure.
(7) Although each of the above-mentioned embodiments has described an example in which a polymer sorbent is adopted as the adsorbent 61, the present disclosure is not limited thereto. Examples of the adsorbent 61 suitable for use may include silica gel and zeolite.
(8) Each of the above-mentioned embodiments has described an example in which the adsorber 60 is continuously rotated in one direction by the electric motor 72 of the driving member 70, causing the adsorbent 61 of the adsorber 60 to move between the moisture-adsorption space 541a and the moisture-desorption space 541b. However, the present disclosure is not limited thereto.
The adsorber 60 may be intermittently rotated in one direction by the electric motor 72 of the driving member 70, causing the adsorbent 61 of the adsorber 60 to move between the moisture-adsorption space 541a and the moisture-desorption space 541b.
The rotational direction of the adsorber 60 by the electric motor 72 of the driving member 70 is not limited to one direction, and may be an inverse direction relative to the one direction. The rotational direction of the adsorber 60 may be switched between the one direction and the inverse direction relative to the one direction at a predetermined time interval, thereby moving the adsorbent 61 of the adsorber 60 between the moisture-adsorption space 541a and the moisture-desorption space 541b.

When the accommodating space 541 is partitioned such that the moisture-adsorption space 541a has substantially the same size as the moisture-desorption space 541b or the like, switching may be performed between the whole adsorbent 61 existing in the moisture-adsorption space 541a and the whole adsorbent 61 existing in the moisture-desorption space 541b. In this case, the adsorber 60 may be intermittently rotated by 180° by the driving member 70.
(9) Although each of the above-mentioned embodiments has described an example in which the driving member 70 for rotating the adsorber 60 is adopted as a moving mechanism that moves the adsorbent 61 of the adsorber 60 between the moisture-adsorption space 541a and the moisture-desorption space 541b, the present disclosure is not limited thereto. The adsorber 60 may be configured of a plurality of adsorption portions, and a structure may be adopted as a moving mechanism to move each adsorption portion in a slide manner between the moisture-adsorption space 541a and the moisture-desorption space 541b.
(10) Like the above-mentioned first to third embodiments, the humidification duct 571 configuring the humidification-side guiding portion is desirably a component separately formed from the air-conditioning duct 20 for the air having its temperature adjusted in the air-conditioning unit 10 or 10A. However, the present disclosure is not limited thereto. For example, the humidification duct 571 may be a component that is integral with the air-conditioning duct 20 on the side of the air-conditioning unit 10 or 10A.
(11) Like each of the above-mentioned first to third embodiments, the adsorption case 51 and the respective suction ducts 521 and 531 are desirably components separately formed from the air-conditioning case 11, and the respective suction ducts 521 and 531 are configured to be detachable from the air-conditioning case 11. However, the present disclosure is not limited thereto. The adsorption case 51 and the respective suction ducts 521 and 531 may be components integral with the air-conditioning case 11.
(12) Like each of the above-mentioned embodiments, the gas-gas heat exchanger 58 is desirably provided to exchange heat between the cooled air passing through the moisture-adsorption space 541a and the humidification air passing through the moisture-desorption space 541b. However, the present disclosure is not limited thereto. For example, the gas-gas heat exchanger 58 may be omitted. (13) Like each of the above-mentioned embodiments, the desorption operation that desorbs moisture, adsorbed in the adsorbent 61, is desirably executed when stopping the humidification of the vehicle interior. However, the present disclosure is not limited thereto, and no desorption operation may be executed.
(14) It is obvious that in each of the above-mentioned embodiments, elements constituting the embodiments are not necessarily essential particularly unless otherwise specified and except when clearly considered to be essential in principle, and the like. Note that the elements constituting the respective embodiments can be appropriately combined to the greatest extent practicable.
(15) When referring to a specific number about a component, including the number, a numerical value, an amount, a range, and the like in each of the above-mentioned embodiments, the component should not be limited to the specific number particularly except when clearly determined to be essential, and except when obviously limited to the specific number in principle, and the like.
(16) When referring to the shape, positional relationship, etc., of a component or the like in each of the above-mentioned embodiments, the component should not be limited to the shape, positional relationship, or the like unless otherwise specified and except when limited to the specific shape, positional relationship, etc., in principle, and the like.

1. A humidification device that is usable for an air-conditioning unit, the air-conditioning unit being configured to accommodate a cooling portion that cools ventilation air and a heating portion that heats the ventilation air, in an air-conditioning case provided with a ventilation passage for the ventilation air into a vehicle interior, the humidification device comprising:
an absorber including an absorbent that absorbs and desorbs moisture;
an adsorption case configured to provide an accommodating space that accommodates the adsorber, the accommodating space including a moisture-adsorption space and a moisture-desorption space, the moisture-adsorption space being configured to adsorb moisture contained in cooled air, produced by the cooling portion, into the adsorbent by circulating the cooled air, the moisture-desorption space being configured to desorb the moisture adsorbed in the adsorbent by circulating heated air produced by the heating portion;
a humidification-side guiding portion that guides humidification air humidified by using the moisture desorbed within the moisture-desorption space, to the vehicle interior;
a moving mechanism that moves at least a part of the adsorbent existing in the moisture-adsorption space of the adsorber to the moisture-desorption space, while moving at least a part of the adsorbent existing in the moisture-desorption space of the adsorber to the moisture-adsorption space; and
a desorption control unit that executes a desorption operation to desorb moisture adsorbed in the adsorbent when humidification of the vehicle interior is stopped.

2.-6. (canceled)

7. The humidification device according to claim 1, wherein
the adsorption case is provided with a partition member that partitions the accommodating space into the moisture-adsorption space and the moisture-desorption space, and
the accommodating space is partitioned by the partition member such that an amount of the adsorbent existing in the moisture-adsorption space is more than an amount of the adsorbent existing in the moisture-desorption space.

8. (canceled)

9. An air conditioner for a vehicle, comprising:
an air-conditioning unit configured to accommodate a cooling portion that cools ventilation air and a heating portion that heats the ventilation air, in an air-conditioning case, the air-conditioning case being provided with a first ventilation passage and a second ventilation passage that are configured to guide the ventilation air having temperatures controlled independently to different areas of a vehicle interior; and
a humidification device that desorbs moisture adsorbed in an adsorbent of an adsorber, humidifies air with the moisture desorbed from the adsorbent, and guides the humidification air to the vehicle interior, wherein
the humidification device includes:
a cold-air introduction passage that guides the cooled air produced by the cooling portion from both the first ventilation passage and the second ventilation passage to the adsorber, as air that causes moisture to be adsorbed into the adsorbent;
a pre-humidification air passage that guides pre-humidification air, which causes moisture adsorbed in the adsorbent to be desorbed from the adsorbent, to the adsorber; and
a post-humidification air passage that guides post-humidification air, which is humidified by the moisture desorbed within the adsorption case, to the vehicle interior.

10. The air conditioner for a vehicle according to claim 9, wherein
the air-conditioning unit and the humidification device are configured such that the air cooled by the cooling portion and heated by the heating portion is taken out of both the first ventilation passage and the second ventilation passage and then guided to the adsorber via the pre-humidification air passage.

11. The air conditioner for a vehicle according to claim 9, further comprising:
a cooled-air return passage that returns the cooled air having passed through the adsorber to the air-conditioning unit.

12. An air conditioner for a vehicle, comprising:
an air-conditioning unit configured to accommodate a cooling portion that cools air and a heating portion that heats the air, in an air-conditioning case, the air-conditioning case being provided with an outside-air ventilation passage and an inside-air ventilation passage, the outside-air ventilation passage being configured to guide the air introduced from an outside of the vehicle into a vehicle interior, the inside-air ventilation passage being configured to guide the air introduced from the vehicle interior to the vehicle interior; and
a humidification device that desorbs moisture adsorbed in an adsorbent of an adsorber, humidifies air with the moisture desorbed from the adsorbent, and guides the humidification air to the vehicle interior, wherein
the humidification device includes:
a cold-air introduction passage that guides the cooled air, produced by the cooling portion, from the outside-air ventilation passage to the adsorber, as air that causes moisture to be adsorbed into the adsorbent;
a pre-humidification air passage that guides pre-humidification air, heated by the heating portion, from the inside-air ventilation passage to the adsorber, as air that causes moisture adsorbed in the adsorbent to be desorbed from the adsorbent; and
a post-humidification air passage that guides out post-humidification air, humidified by the moisture desorbed within the adsorption case, to the vehicle interior.

13. The air conditioner for a vehicle according to claim 12, wherein
the air-conditioning unit and the humidification device are configured such that the air cooled by the cooling portion and heated by the heating portion is taken out of the inside-air ventilation passage and then guided to the adsorber via the pre-humidification air passage.

14. The vehicle air conditioner according to claim 12, wherein
the air-conditioning unit is provided with two outside-air ventilation passages as the outside-air ventilation passage and configured to guide air having temperatures controlled independently to different areas of the vehicle interior through the two outside-air ventilation passages,
the air-conditioning unit is provided with two inside-air ventilation passages as the inside-air ventilation passage and configured to guide air having temperatures controlled independently to different areas of the vehicle interior through the two inside-air ventilation passages, and
the air-conditioning unit and the humidification device are configured such that
the cooled air is taken out of the two outside-air ventilation passages and then guided to the adsorber via the cold-air introduction passage, and
the pre-humidification air is taken out of the two inside-air ventilation passages and then guided to the adsorber via the pre-humidification air passage.

15. The air conditioner for a vehicle according to claim 12, further comprising:
a cooled-air return passage that returns the cooled air having passed through the adsorber to the air-conditioning unit.
